(19) United States
(12) Patent Application Publication
(10) Pub. No.: US 2011/0178861 A1
(43) Pub. Date: Jul. 21, 2011

(54) ELECTRONIC REWARD GENERATION

(76) Inventor: RANDOLPH KEN GEORGI, Mill Valley, CA (US)

(21) Appl. No.: 12/942,693

(22) Filed: Nov. 10, 2010

Related U.S. Application Data
(60) Provisional application No. 61/264,610, filed on Nov. 25, 2009.

(51) Int. Cl. G06Q 30/00

(52) U.S. Cl. 705/14.25

(57) ABSTRACT

A system (and method) are configured to generate vouchers to exchange for rewards associated with a physical commerce center having a plurality of retailers. The vouchers are disseminated by several modes, including issuance apparatuses. Voucher-related data is tracked in a system including a central computer, issuance apparatuses, other remote devices, and a database. On behalf of a shopping center, vouchers exchangeable for rewards serve to attract visitor traffic, promote consumer spending, and bolster rents, occupancy, and tenant retention. Advances are achieved by differentiating and automating functions at a shopping center level, as distinct from a retailer level. Functions include voucher dissemination, qualification, verification, tracking, redemption, and fraud countermeasures; brokering of rewards with reward providers; administration of surveys to procure marketing information; and issuance of reports. The configuration enables formation of a market of reward providers.

### CROSS REFERENCE TO RELATED APPLICATIONS

This application claims the benefit of U.S. Provisional Application No. 61/264,610, filed Nov. 25, 2009, titled “Electronic Reward Generation,” the contents of which is incorporated by reference in its entirety.

### BACKGROUND

1. Field of Art

The disclosure generally relates to the field of electronic commerce, and more specifically, analyzing transactions from unaffiliated (or disparate) entities associated with one or more physical locations.

2. Description of the Related Art

Two common methods are employed to market or promote a shopping center or a retailer in a shopping center. One is retailer advertising, where an individual retailer purchases on its own behalf advertising in media such as magazines, newspapers, radio, television, direct mail, outdoor billboards, signs, and websites. In a second method, a shopping center marketing department, often using lease-required advertising funds collected from retail tenants, spends funds in the same type of media to advertise or promote the shopping center as a whole. The second method usually attempts to attract consumers to the shopping center itself, not necessarily to individual retailers.

The advertising function as applies to shopping centers is dominated by two main methodologies. The first methodology includes identity, brand, or image advertising, which exposes a local consumer market to the advertiser through name recognition, brand identity, features, attractions, benefits, and similar informational characteristics which attract and reinforce consumer patronage, familiarity, and loyalty. This methodology typically produces consumer awareness, yet is not a call-to-action to evoke a specific response. Image advertising is a common mode employed by a shopping center.

The second methodology is inducement, or call-to-action, advertising which generally features sales, discounts, coupons, special offers, rewards, incentives, premiums, closeouts, and similar forms of value offered to attract consumers and evoke desired consumer behavior. Coupons and sales of discounted goods and services generally lie in the province of a retailer, not a shopping center, and are typically intended to drive traffic to an individual retailer or chain, not usually to a group of diverse stores as is ordinarily found in a shopping center. Inducement advertising at the level of a shopping center is uncommon and fraught with difficulties described below.

Conventional advertising and marketing methods require an advertiser to spend in advance to attract business by methods which are inherently uncertain, while results vary unpredictably across different advertising campaigns. Consumer response is unknown before marketing expenditures are committed. Marketing efforts often fail to produce desired results. While getting bodies into a shopping center is crucial to success, methods of doing so can be costly, uncertain, risky, and ineffective.

Coupled with added constraints described below, the marketing problem of shopping centers is challenging. Effective proactive marketing methods, such as inducements, pose thorny obstacles, leaving a shopping center hamstrung to market itself.

Compounding the difficult marketing task of a shopping center are the constitution and infrastructure of its retailers. A shopping center consists of a mix of diverse retailers which often include single location sole proprietors, franchisees of regional or national franchisors, branches of multi-location chains, department stores, and/or big box stores. Some are anchor stores. These businesses vary widely in types of goods and services sold, business models, and scale. Headquarters of retailers in a given shopping center may be local or dispersed around the country. Retailers' marketing decision-making is even more scattered, with ad agencies, media buyers, and multiple media involved. Large retailers, which often have dozens, hundreds, or thousands of locations, commonly operate their own centrally-managed marketing efforts exclusive of local shopping center-sponsored promotions. Those large retailers often do not spend marketing funds locally, relying instead on national advertising which is of little value to the shopping center owner. Shopping center retailer branches usually have few or no funds or discretion to advertise locally. Lease-required advertising funds are sometimes collected to address these problems, yet such funds, if they exist, are typically spent as described above for image ads of limited effectiveness.

Adding to the marketing challenge, in any shopping center there is great variation among retailers in POS register systems, computer hardware and software systems, accounting methodologies, databases, and equipment. Incompatible systems track data in different ways, including transactions, inventory, coupons, account histories, pricing, and other data. Further, retailers have employees of varied training, skills, and frequency of turnover, which represents an added obstacle to administer any common promotional program. Retailers' advertising budgets, operating capital, business strategies, media choices, target markets, marketing needs, profit margins, inventory, and seasonality vary widely, thereby further rendering coordinated or cooperative marketing efforts difficult among a group of disparate retailers.

For the reasons cited above, shopping center marketing departments are limited in proactive and effective promotional methods, and tend instead to rely on marketing methods with real estate roots, such as retail tenant selection and mix; architecture, design, and environment creation. Such real estate-based marketing methods appeal to different consumer motivations than conventional retailer marketing methods, making a shopping center merely a destination which provides a stimulating, interesting, safe, and convenient experience for shopping. These factors are not a basis for immediate consumer action. While such real estate-based marketing strategies are important promotional tools and attractants, they are necessarily passive and indirect, detrimental to the shopping center's interests.

Taken together, these factors sharply limit the ability of a shopping center to implement mutually beneficial promotional schemes among multiple retailers. Having significant incompatibilities and hurdles, retailers at shopping centers are ill-equipped to participate in a centrally organized shopping center marketing program, such as common coupons which might be redeemed at any or all retailers at a shopping center.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of components of an example machine able to read instructions from a machine-readable medium and execute them in a processor (or controller).

FIG. 2A illustrates one embodiment of an electronic reward generation system for shopping centers.

FIG. 2B illustrates one embodiment of an electronic reward generation system in a shopping center.

FIG. 3A illustrates one embodiment of components of a voucher issuance apparatus.

FIG. 3B illustrates one embodiment of different views of a voucher issuance apparatus.

FIG. 3C illustrates one embodiment of different tray positions of a document processing assembly in a voucher issuance apparatus.

FIG. 3D illustrates one embodiment of components of a document processing assembly in a voucher issuance apparatus.

FIG. 4 illustrates one embodiment of a method of providing vouchers for an electronic reward generation system for a shopping center.

FIG. 5 illustrates one embodiment of a method of issuing a reward based on voucher redemptions in an electronic reward generation system for a shopping center.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of a disclosed system (and method and computer readable storage medium) includes voucher-based rewards in a shopping center. A shopping center increases consumer traffic and spending by hosting a rewards system, based on vouchers. An issuance apparatus authenticates purchase receipts from retailers inside the shopping center to qualify for a reward and to prevent fraud, and issues vouchers typically based on the total value of receipt amounts. Owners or managers of a shopping center can develop and adjust a schedule of spending thresholds at which users can qualify to obtain vouchers. Other modes of voucher dissemination may be used to attract consumers to the shopping center. Businesses inside and outside of the shopping center provide rewards in exchange for the vouchers.

In one embodiment, a process, executable through a computing machine (or system), receives receipts corresponding to completed transactions at retailers within a predetermined time period and generates one or more vouchers exchangeable for a reward. The retailers are associated with a shopping center, and at least two retailers do not have a corporate affiliation with one another (disparate). Each of the receipts is analyzed to determine the value of the transaction recorded on the receipt. The values of the receipts are summed, totaled, or otherwise assessed, to determine whether a threshold criterion has been satisfied. Assessment other than a sum may include a weighted sum, visit frequency, or any other formula or measurement by which a threshold may be satisfied. A quantity of vouchers corresponding to the threshold criterion is determined. A voucher is outputted if the threshold criterion is met. Alternative information may be outputted if the summed or assessed value of the receipts does not satisfy the threshold criterion, including informing the user of the amount of spending required to meet the threshold criterion.

In one embodiment, a machine (or system) that rewards shoppers, or consumers, in a shopping center includes a database having entries corresponding to steps in the lifecycle of each voucher (e.g., issuance and redemption), a schedule of rewards and reward providers, and a list of each retailer within a shopping center. The system includes an analysis engine that receives data about the value of each transaction completed with a retailer within a shopping center. The analysis engine calculates the total value of the transaction(s) in order to determine whether it exceeds a predetermined threshold to qualify for a reward. An output engine generates one or more vouchers if the predetermined threshold is satisfied, enabling exchange for a reward from a contracted reward provider. If the threshold is not satisfied, the output engine generates a notification of not satisfying the predetermined qualification threshold.

### Computing Machine Architecture

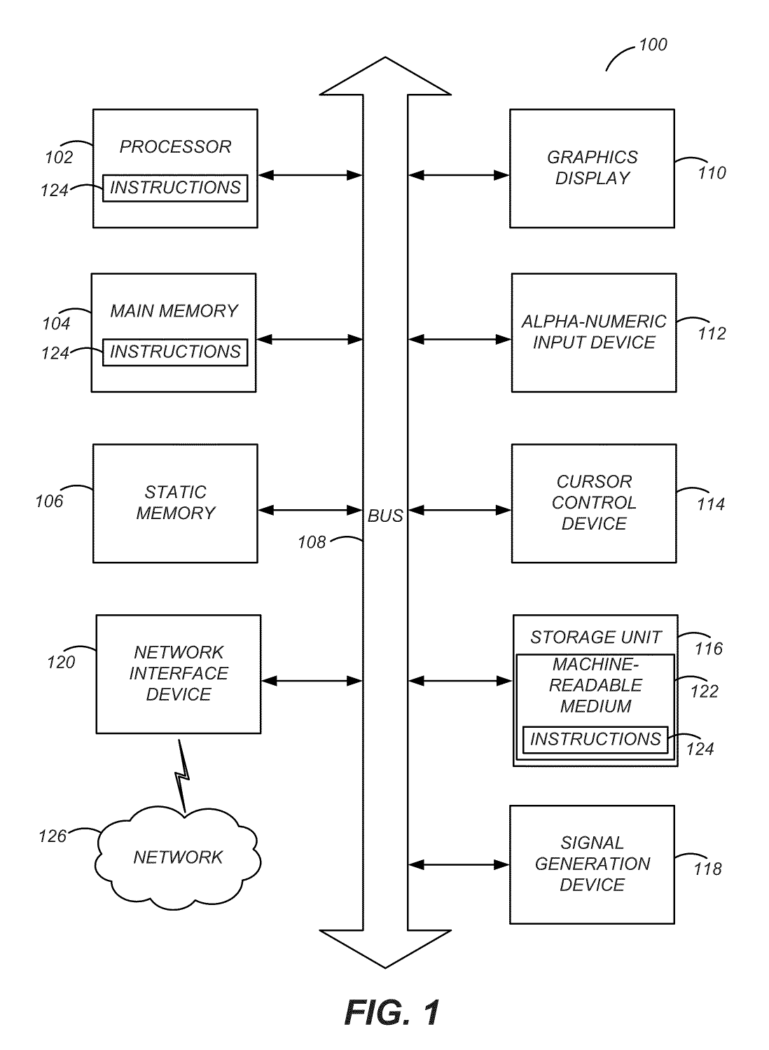

FIG. (FIG. 1 is a block diagram illustrating components of an example machine able to read instructions from a machine-readable medium and execute them in a processor (or controller). This example machine provides a context for machine structure when configuring processes as described herein. Specifically, FIG. 1 shows a diagrammatic representation of a machine in the example form of a computer system 100 within which instructions 124 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 124 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 100 includes a processor 102 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 104, and a static memory 106, which are configured to communicate with each other via a bus 108. The computer system 100 may further include graphics display unit 110 (e.g., a plasma display panel (PDP), a liquid crystal display (LCD), a projector, or a cathode ray tube (CRT)). The computer system 100 may also include alphanumeric input device 112 (e.g., a keyboard), a cursor control device 114 (e.g., a mouse, a trackball, a joystick, a touchscreen, a motion sensor, or other pointing instrument), a storage unit 116, a signal generation device 118 (e.g., a speaker), and a network interface device 120, which also are configured to communicate via the bus 108.

The storage unit 116 includes a machine-readable medium 122 on which is stored instructions 124 (e.g., software) embodying any one or more of the methodologies or functions described herein. The instructions 124 (e.g., software) may also reside, completely or at least partially, within the main memory 104 or within the processor 102 (e.g., within a processor's cache memory) during execution thereof by the computer system 100, the main memory 104 and the processor 102 also constituting machine-readable media. The instructions 124 (e.g., software) may be transmitted or received over a network 126 via the network interface device 120.

While machine-readable medium 122 is shown in an example embodiment to be a single medium, the term “machine-readable medium” should be taken to include a single medium or multiple media (e.g., a centralized or distributed database, or associated caches and servers) able to store instructions (e.g., instructions 124). The term “machine-readable medium” shall also be taken to include any medium that is capable of storing instructions (e.g., instructions 124) for execution by the machine and that cause the machine to perform any one or more of the methodologies disclosed herein. The term “machine-readable medium” includes, but is not limited to, data repositories in the form of solid-state memories, optical media, and magnetic media.

### Overview of Electronic Reward Generation in a Physical Commerce Center

A physical commerce center, also called a shopping center, may be found in various forms. A “shopping center” includes any venue, center, zone, grouping of retailers, or place for shopping or engaging in any consumer transaction. A “shopping center” also includes, for example, a shopping mall of any type or size; a set of affiliated or organized retailers; a business district; a retail or commercial zone; a merchants' association; a chain store or department store; and one or more of a plurality of retailers, freestanding stores, and/or service businesses, restaurants, and similar establishments which transact with consumers. A shopping center may or may not consist of geographically contiguous stores. A shopping center further includes, for example, any airport mall, enclosed mall, entertainment complex, fashion mall, festival or themed marketplace, galleria, mixed-use center, neighborhood center, regional center, commercial strip, super-regional center, urban mall, or village center.

Any organization, association, group, or entity which includes or represents a plurality of retailers or other businesses that engages in collective marketing is also included as a shopping center. A shopping center consisting of “freestanding stores” is a set or group of non-contiguous retailers and/or shopping centers, or a combination thereof, organized for marketing purposes. A conventional multi-store shopping center, such as a mall, and a grouping of freestanding stores organized for marketing purposes are described herein for illustration purposes. However, electronic reward generation is not limited to shopping centers. Other settings, including a transportation hub, a downtown district, stadium, exhibition, auto row, convention center, markets, and industries, may be utilized for the purpose of electronic reward generation.

Shopping center owners generally include real estate investment trusts (REITs), real estate investors, property developers, and property managers. In a typical example, a REIT derives an estimated 94% of rental income from Mall and Freestanding Store tenants' rents, with the remaining 6% of rent coming from Anchors, such as department stores. Shopping center rents tend to be established on the basis of visitor traffic, demographics, and market conditions. Increased visitor traffic and spending justify rent increases. Shopping centers often generate income in various ways, including collecting a base or minimum rent, a percentage rent based on sales, and fees or reimbursement for taxes, utilities, insurance, advertising, and other expenditures related to shopping center operations. Thus, a shopping center is incentivized to attract more consumer traffic and spending.

A shopping center owner, thus, has coincident interests with its retail tenants. However, a shopping center owner benefits from increased visitor traffic and spending because these factors serve as a basis for setting rents obtained from the retail tenants. The retail tenants benefit directly from sales of goods and services. A shopping center owner has overlapping, yet different, economic interests compared to its retail tenants. The business model of shopping centers differs from retailers because retailers are more concerned with sales, inventory, the cost of point of sale (POS) equipment, operations, and labor. Consumer promotional marketing, retail economics, seasonal timeframes, and business strategies dominate the concerns of retailers, all differing from the principal concerns of shopping centers.

Reflecting the real estate nature of its business, a shopping center's marketing concerns include attracting and retaining tenants to maximize occupancy, and setting optimal rents in leases for the real estate space under its control. These factors contribute directly to the shopping center's earnings. Traffic volume and visitor spending, for example, are factors in setting rents because the shopping center typically receives, in addition to base rent, a percentage rent in the range of three percent to six percent of its retail tenants' gross revenue. More visitors typically result in more spending, increasing the retail tenants' gross revenue while also increasing the shopping center's revenue stream. Additional visitors also provide a quantitative basis for setting rents and attracting strong tenants. Tenant retention has significant value, aside from rental income, because replacing tenants and filling vacancies are costly. Additionally, attracting and retaining high quality, established retail tenants are important in attracting visitors to the shopping center. Hence, the disclosed configurations provide system and method configurations of electronic reward generation to beneficially address these issues by increasing visitor traffic volume and increasing spending at retailers of the shopping center.

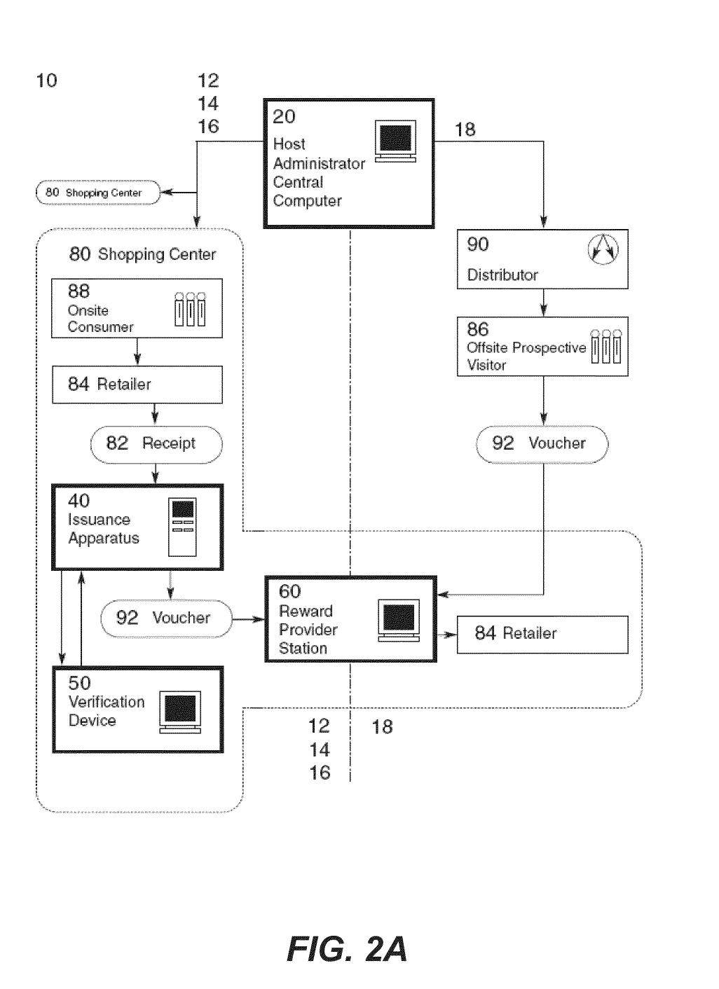

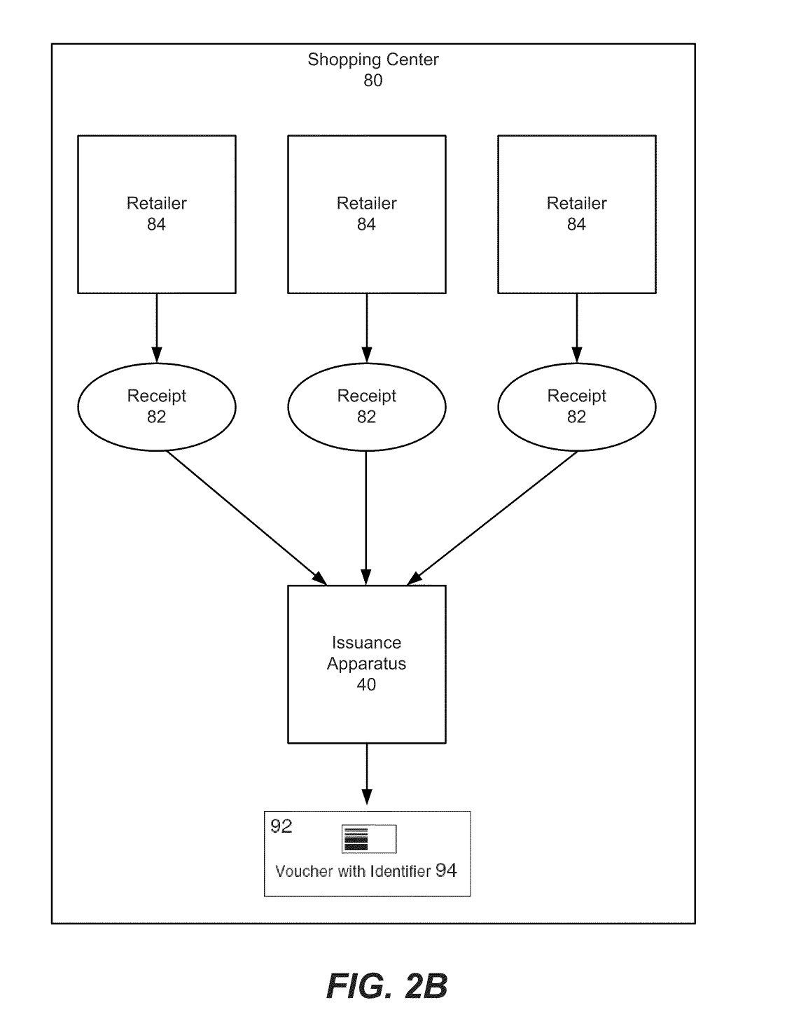

Referring now to FIGS. 2A through 2B, illustrated is an overview of electronic reward generation in a physical commerce center, or shopping center. An electronic reward generation system 10 includes a host administrator central computer 20 (also referred to as a “host administrator”), a shopping center 80, an offsite prospective visitor 86, a distributor (or distribution system) 90, and a reward provider (or station) 60. The host administrator central computer 20 communicatively couples with devices in the shopping center 80 and interfaces with the distributor 90. The offsite prospective visitor 86 communicatively couples (or interfaces) with the distributor 90, and becomes a voucher holder upon receiving one or more vouchers 92 to redeem at a reward provider 60. The offsite prospective visitor 86 also communicatively couples (or interfaces) with the reward provider (or station) 60, by redeeming one or more vouchers 92 in order to receive a reward. In one embodiment, the reward provider (or station) 60 is communicatively coupled with the central computer 20. A reward provider (or station) 60 may be a retailer 84 located in the shopping center 80, or may be located offsite from the shopping center 80. A retailer 84 includes any retailer, service business, restaurant, concession, kiosk, or other tenant or business associated with the shopping center which transacts with consumers. Other retailers 84 may include businesses which contract with the shopping center even though the businesses may not be physical tenants, e.g., vending machine operators, co-promoters and sponsors (offsite events, movie promotions, financial and travel services), and data distribution services (e.g., music, book, and movie downloads) that transmit data to the issuance apparatuses. In one embodiment, in which any object is offered for sale, such as a gift card or ticket, and is outputted by an issuance apparatus, a retailer 84 includes the host administrator 20 operating the issuance apparatus 40.

The shopping center 80 further includes an onsite consumer 88, a retailer 84, an issuance apparatus 40, a reward provider (or station) 60, and a verification device 50. Onsite consumer 88 is any visitor to a shopping center. The onsite consumer 88 interfaces with the retailer 84, the receipt 82 issued by retailer 84, and the issuance apparatus 40. The issuance apparatus 40 is communicatively coupled with the central computer 20 and the verification device 50. The onsite consumer 88 communicatively couples (or interfaces) with the reward provider (or station) 60, by redeeming one or more vouchers 92 in order to receive a reward from a reward provider, which is often a retailer 84. Thus, the onsite consumer 88 is a voucher holder after receiving generated vouchers 92 from the issuance apparatus 40.

It is noted that the computing systems (or configurations) described with respect to the electronic reward generation system 10 are in one embodiment as described with FIG. 2A, but are further configured so that the process described below may be embodied as instructions 124 and data stored in the storage unit 116 and/or memory 104, executable by the processor 102 as illustrated in FIG. 1.

The electronic reward generation system 10 benefits the shopping center 80 by providing a basis for optimizing rent as well as attracting and retaining retail tenants. Retailers 84, or retail tenants, ordinarily pay the shopping center 80 (owner or manager of the shopping center 80) rent commensurate with the physical space occupied within the shopping center 80 as well as the market value of a lease at the shopping center's property. By providing an electronic reward generation system 10, the shopping center 80 is increasing its market value to tenants due to higher volumes of visitor traffic and spending at the shopping center 80, reflecting consumers taking advantage of the rewards program and system.

An electronic reward generation system 10 provides voucher inducements (“vouchers”) to consumers using several voucher dissemination modes, including but not limited to 12, 14, 16, and 18 in FIG. 2A. Modes 12, 14, 16, and 18 illustrate voucher flow from a host administrator through several steps to reward provider 60. Vouchers are disseminated to an onsite consumer 88 using various methods, including voucher dissemination modes 12, 14, and 16, and to a prospective visitor 86 using voucher dissemination mode 18. Modes 12, 14, 16, and 18 promote visits and spending at retailers 84 to the benefit of shopping center 80 and the retailers 84.

In voucher dissemination mode 12, or “Shop First” mode 12, an onsite consumer 88 visits a shopping center 80 on his or her own initiative. After spending a sufficient amount for goods or services at one or more retailers 84 in the shopping center 80, the onsite consumer 88 is issued at least one voucher exchangeable for a reward. In the Shop First mode 12 of voucher dissemination, the onsite consumer 88 shops at one or more retailers 84, receives receipts 82 or equivalent proofs of purchase, goes to an issuance apparatus 40 to qualify his or her purchases by submitting receipts or other proofs, receives at least one voucher if the total amount of purchases qualify the onsite consumer 88 for a voucher, as established at a verification device 50, and then is able to redeem the voucher at a reward provider (or station) 60.

Note that retailers only need to provide a transaction or purchase receipt 82 to the consumer, as is given in the normal course of business using standard point of sale (POS) equipment so that participation in this electronic reward generation system 10 does not require additional retailer equipment, labor, data entry, or active operational involvement other than what is used in the ordinary course of business. The transaction or purchase receipt may be a conventional paper receipt or may include an electronic receipt such as an SMS text message or e-mail based receipt transmitted to a unique user identifier (e.g., issuance apparatus 40, mobile phone, or e-mail account). As will be further described herein, the receipt may include particular details on the transactions for use with the rewards generation system 10.

In voucher dissemination mode 14, or “Outside Payer” mode 14, in one embodiment, a survey is provided to an onsite consumer 88. As an incentive to visit the shopping center 80, a survey is administered at an issuance apparatus 40, enabling an onsite consumer 88 to receive one or more vouchers for taking a survey, for example, for a market research firm. These vouchers may be redeemed at any active reward provider (or station) 60, as discussed below. This mode is labeled an “Outside Payer” mode because the survey is administered to solicit information for use by a third party market research or data collection service, which pays for the vouchers to be redeemed by the onsite consumers 88 who complete the survey. In another embodiment, any person in the shopping center market area is encouraged to take one or more surveys disseminated through other communication channels, such as at the host administrator's or shopping center's website or in an e-mail. Upon sufficient completion of a survey, a virtual voucher with a unique identifier may be provided to the survey taker to encourage him or her to visit the shopping center 80. A virtual voucher is a coded value, in printed or other format, which can be entered at an issuance apparatus 40 and validated in the central computer 20 database to exchange for a physical voucher 92 printed by the issuance apparatus 40, or a virtual voucher may be submitted at a reward provider (or station) 60 to exchange for a reward.

In voucher dissemination mode 16, or “Credit Card Transactions” mode 16, a specific credit card is used by an onsite consumer 88 visiting the shopping center 80 to shop and spend at one or more retailers 84 at shopping center 80 to qualify for vouchers. The onsite consumer 88 is issued a voucher as a reward for spending a threshold amount using the specific credit card at any of the retailers 84 in the shopping center 80. Credit card use is verified using object detector 430 in issuance apparatus 40.

In voucher dissemination mode 18, or “Reward First” mode 18, an offsite prospective visitor 86 is initially not located on the shopping center 80 property. As an incentive for the offsite prospective visitor 86 to visit the shopping center 80, a voucher is provided to the offsite prospective visitor 86 by offsite distributor 90 via physical issuance, mail, e-mail, social network, text message, or any other communication channel. Typically the offsite distributor 90 purchases vouchers, often in bulk, for such distribution for its own marketing, client relations, or other purposes. Incentivized by the voucher, the offsite prospective visitor 86 then travels to a reward provider (or station) 60, commonly located within the shopping center 80, to redeem the voucher. As a result, the offsite prospective visitor 86 adds to the visiting traffic volume and may also contribute to spending at the retailers 84 of the shopping center 80. Each voucher step, including the voucher sale, identification of distributor 90, and redemption, is recorded in the central computer 20 database.

Multiple shopping centers 80 are illustrated in FIG. 2A because, in one embodiment, an electronic reward generation system 10 may include more than one shopping center 80 and a plurality of shopping center owners. A shopping center owner may encourage consumers to visit the multiple shopping centers 80 operated by the same owner. The result is a networked system in which rewards are disseminated on behalf of multiple shopping centers. A host administrator central computer 20, an issuance apparatus 40, a verification device 50, a reward provider (or station) 60, a receipt 82, and a voucher 92 are illustrated in FIGS. 2A-B. Each of the host administrator central computer 20, issuance apparatus 40, verification device 50, and reward provider (or station) 60 is a computer system 100 as described above and illustrated in FIG. 1. Although only one central computer 20, issuance apparatus 40, verification device 50, reward provider (or station) 60, receipt 82, and voucher 92 are illustrated, multiple central computers 20, issuance apparatuses 40, verification devices 50, reward providers (or stations) 60, receipts 82, and vouchers 92 may be implemented in an electronic reward generation system 10.

FIG. 2B illustrates a high-level block diagram of a shopping center 80 in further detail according to one embodiment of the electronic reward generation system 10. A shopping center 80 includes retailers 84, receipts 82, an issuance apparatus 40, and a voucher 92 with a unique identifier 94. Retailers 84 each generate receipts 82 as a result of transactions or purchases by onsite consumers 88, as illustrated in FIG. 2A. The receipts 82 communicatively couple with the issuance apparatus 40. The issuance apparatus 40 generates a voucher 92 that is assigned a unique identifier 94.

In the shopping center 80, multiple retailers 84 provide receipts 82 to one or more onsite consumers 88. Note that the receipts 82 may be pooled by multiple onsite consumers 88 to qualify for a reward, so as to enlarge the market, facilitate acquisition of rewards by consumers, and drive traffic and spending. Using the issuance apparatus 40, communicatively coupled with verification device 50, the receipts 82 are validated and it is determined whether a spending or qualification threshold has been met to qualify for one or more vouchers 92.

Vouchers 92 may include both virtual and physical vouchers 92. In one embodiment, physical vouchers are printed vouchers, with unique identifiers, that may be collected by consumers for a reward. Other embodiments of physical vouchers include encoded magnetic strips on cards comprised of plastic, paper, or other materials; electronically encoded chips on a card, including radio frequency or other technologies; or any other means by which a unique identifier may be associated with a physical object suitable for use in exchange for a reward. Virtual vouchers may be in the form of a special code, or a text message, e-mail, or other indication of a voucher, or equivalent electronic or other conveyance of reward value for the same purpose within the reward system, without necessarily a physical manifestation of the voucher. Dissemination of vouchers, as mentioned above, may include multiple methods, such as issuance of complimentary physical or virtual vouchers by a distributor 90 to entice would-be consumers to visit a shopping center, virtual vouchers issued to consumers upon completion of one or more surveys at a website, and physical vouchers issued to consumers upon meeting a spending threshold at a shopping center as verified by an issuance apparatus and verification device 50, as described below. A voucher 92 also includes a unique identifier 94 and, in one embodiment, an expiration date. The unique identifier 94 may be in the form of a special code, such as a barcode, or unique text string, or both. In one embodiment, a sweepstakes voucher, not exchangeable for a reward, may be issued and printed with a unique identifier 94 and the user's image. This free sweepstakes voucher may be issued to entrants as proof of sweepstakes entry and identifies each unique user that used the issuance apparatus for usage tracking purposes. The sweepstakes voucher may be printed on a different type of paper than a voucher 92 that is exchangeable for rewards to prevent confusion.

### Issuance Apparatus for Electronic Reward Generation System

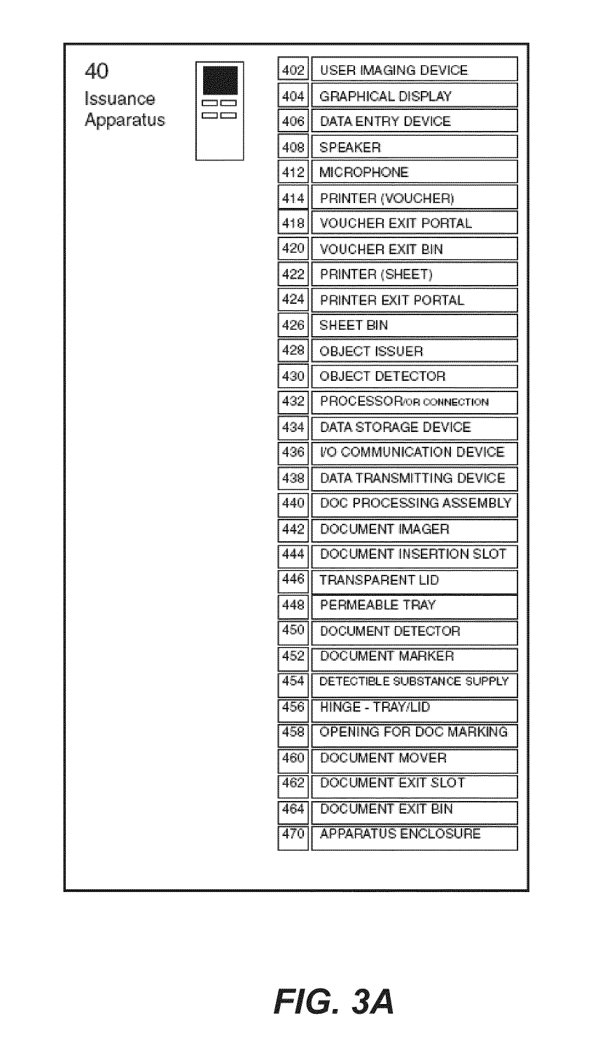

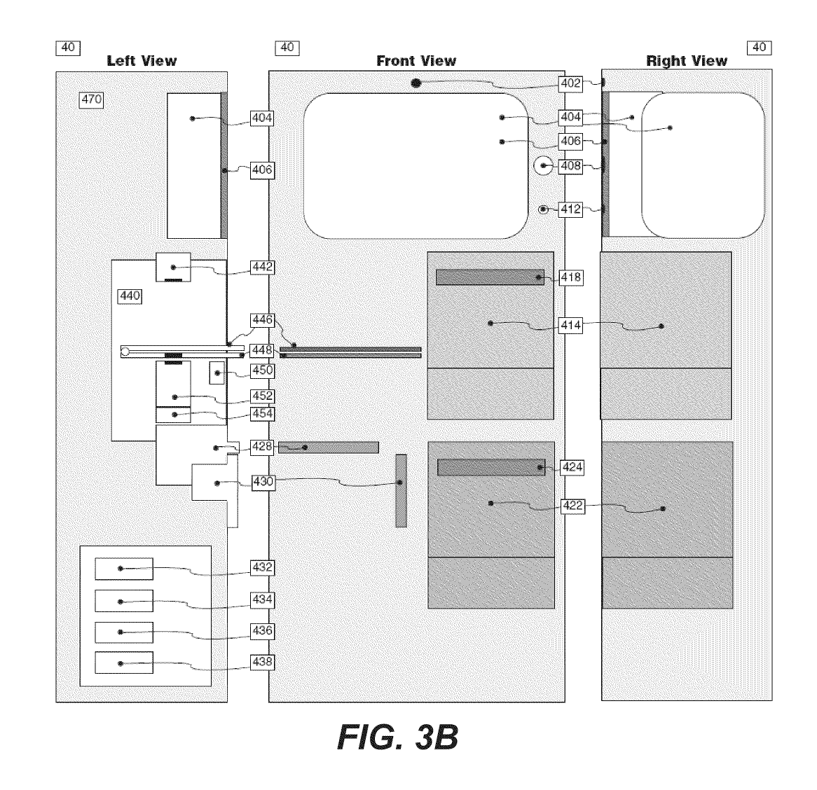

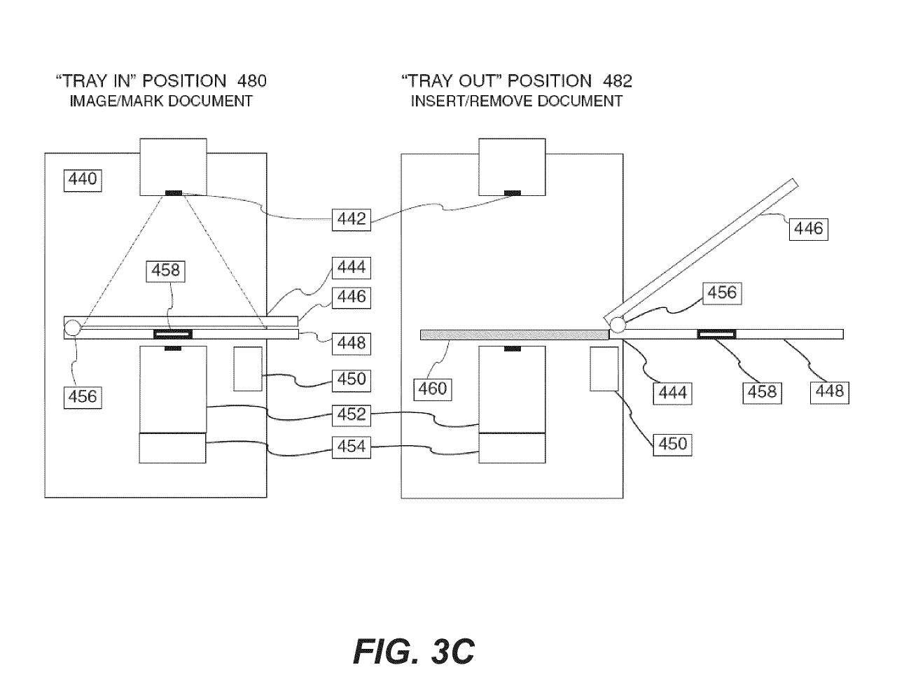

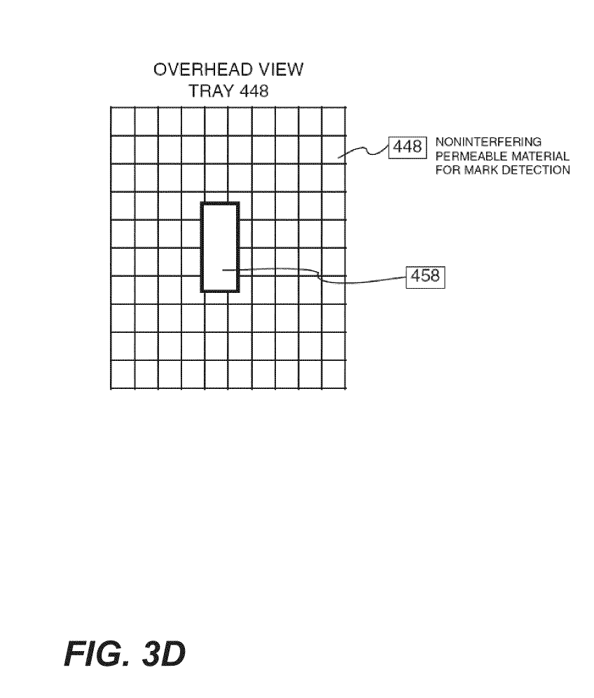

Referring now to FIGS. 3A through 3D, illustrated are components and various views of an issuance apparatus 40 in one embodiment. The issuance apparatus 40 may be configured as a kiosk, for indoors or outdoors use, and installed in high traffic areas of a shopping center to attract and drive traffic to the shopping center by providing reward services and other services, including surveys. Multiple issuance apparatuses may be installed throughout a shopping center 80 with each issuance apparatus connected to a host administrator central computer 20. For multiple shopping centers, all of the issuance apparatuses may connect to the host administrator central computer 20. Thus, a network of issuance apparatuses is formed. In other embodiments, an issuance apparatus 40 is configured as a workstation located at, for example, a physical customer service booth (e.g., information or help desk). A person at the shopping center customer service booth, using a device connected to a host administrator central computer 20, may assist users at the workstation to issue vouchers. In other embodiments, an automated teller machine (ATM), ticketing machine, or other electronic kiosk or apparatus may be configured as an issuance apparatus 40.

In a typical embodiment, the issuance apparatus 40 includes a user imaging device 402, a graphical display 404, a data entry device 406, a speaker 408, a microphone 412, a printer for vouchers 414, a voucher exit portal 418, a voucher exit bin 420, a printer for sheets 422, a printer exit portal 424, a sheet bin 426, an object issuer 428, an object detector 430, a processor or connection to a remote processor 432, a data storage device 434, an input/output (I/O) communication device 436, a data transmitting device 438, a document processing assembly 440, a document imager 442, a document insertion slot 444, a transparent lid 446, a permeable tray 448, a document detector 450, a document marker 452, a detectable substance supply 454, a hinge for the tray and lid 456, an opening for document marking 458, a document mover 460, a document exit slot 462, a document exit bin 464, and an apparatus enclosure 470.

The processor 432 is communicatively coupled to the data storage device 434, the input/output (I/O) communication device 436, and the data transmitting device 438. Further, in a typical embodiment, the processor 432 is communicatively coupled to the user imaging device 402, the graphical display 404, the data entry device 406, the speaker 408, the microphone 412, the printer for vouchers 414, the printer for sheets 422, the object issuer 428, the object detector 430, the document processing assembly 440, the document imager 442, the document detector 450, the document marker 452, and the document mover 460.

A processor, or a connection to a remote processor 432, is included in the issuance apparatus 40 for executing the instructions of various modules running on the issuance apparatus 40. The processor 432 includes the functionality of the processor 102 described above and illustrated in FIG. 1. A data storage device 434 stores data that is entered into the issuance apparatus 40. Input and output (I/O) communication device 436 enables transmitting instructions and data via an input/output device, such as a network interface device described above. A dedicated communication line may be used by the I/O communication device 436. Data transmitting device 438 may include a device for connecting to the Internet to transmit instructions and data, and includes the functionality of the network interface device 120 described in FIG. 1. The data storage device 434 includes the functionality of the storage unit 116 described in FIG. 1. Likewise the I/O communication device 436 includes the functionality of the network interface device 120 described with FIG. 1. Further, although not illustrated and described in FIGS. 3A-3D, the functionality of one or more other structural features described in FIG. 1, e.g., main memory 104, static memory 106, graphics display 110, alpha-numeric input device 112, and cursor control device 114, may be incorporated with the issuance apparatus 40.

Data associated with each voucher, transaction, or event is entered in a database connected to the central computer 20. Each voucher 92 is represented by a unique database record and a unique identifier 94 which is affixed to or printed on each voucher. The unique identifier 94 is associated on a one-to-one basis with each database record, and data associated with each voucher 92 is inputted into the corresponding database record. Data is initially entered or later added to the corresponding database record at various stages in the lifecycle of a voucher 92. The voucher 92 is associated, as needed, with identification, dissemination, qualification, survey, redemption, and other types of data. Useful correlations may be generated for market research, data mining, and/or other purposes.

As shown in FIG. 3B, the apparatus enclosure 470 provides physical support for the various components of the issuance apparatus 40. The user imaging device 402, graphical display 404, data entry device 406, speaker 408, microphone 412, document processing assembly 440 with several components, object issuer 428, object detector 430, and other components, are embedded within the apparatus enclosure 470. The user imaging device 402 may be communicatively coupled with the graphical display 404. The graphical display 404 is communicatively coupled with the data entry device 406. The processor 432, data storage device 434, input/output (I/O) communication device 436, and data transmitting device 438 are each communicatively coupled with the user imaging device 402, the graphical display 404, the data entry device 406, speaker 408, microphone 412, object issuer 428, object detector 430, document imager 442, document detector 450, document marker 452, and printers 414 and 422.

One or more input/output (I/O) communication devices 436, not shown in FIG. 3B, may be communicatively coupled to each component, including printers 414 and 422, object issuer 428, object detector 430, document imager 442, document detector 450, document marker 452, and other components, for purposes of monitoring, maintenance, and/or managing printer and/or component functionality, status, replenishing consumables, and other features. The one or more communication devices 436 enable communication to central computer 20 or any other device for onsite or remote monitoring purposes and to enable notification to the shopping center and/or servicing facility of a need for repair, restocking, and the like.

The issuance apparatus 40 may include various communications devices for data entry, capturing images of receipts to qualify for vouchers, recording specific user characteristics, performing live interviews of users for surveys, obtaining help from the shopping center service desk, and other communications. In the front and right views of the issuance apparatus 40, as illustrated in FIG. 3B, a user imaging device 402, such as a webcam or other camera device, captures an image of a user in a digital format. The image may be printed on a voucher for validation purposes upon redemption, or for anti-fraud or abuse purposes. One or more graphical displays 404 provide a video display to the user, such as a display monitor or programmable sign suitable, for example, for a user interface, advertising, and messaging. One or more graphical displays may be physically separated from, but communicatively coupled with issuance apparatus 40. A data entry device 406 includes a data input device, such as a touchscreen device coupled with one or more graphical displays 404, or a keyboard and/or pointing device. Using the data entry device 406, the user may input data into the issuance apparatus 40, including a purchase receipt amount, an answer to a shopping center survey question, a zip code, and/or an e-mail address. A speaker 408 and a microphone 412 may be also used to interact with the user via voice and sound communication devices, and to communicate to remote devices. A shopping center survey includes several survey questions, prepared by the management of the shopping center. Other surveys, such as market research surveys, are prepared by third parties. The survey questions may be changed at any time and are posed to users of the issuance apparatus 40 in the qualification and verification process.

Each interaction by a user with the issuance apparatus 40 generates session data, which includes session identification information, issuance apparatus identification, shopping center identification, consumer data, answers to questions posed to consumers taking surveys, document images, user images, spending amounts, voucher issuance authorization, verifier identification, voucher identifier(s) issued, and the like. This session data is stored in the data storage device 434 and communicated to the database in the central computer 20 for storage in storage unit 116.

The issuance apparatus 40 includes an apparatus enclosure 470 configured to provide physical support for two printing configurations and other devices. The apparatus enclosure 470 includes a first printer 414, a voucher exit portal 418, a voucher exit bin 420, a second printer 422, a printer exit portal 424, a sheet bin 426, an object issuer 428, an object detector 430, and document processing assembly 440. As illustrated in FIG. 3B, the first printer 414 is coupled with the voucher exit portal 418, while the second printer 422 is coupled with the printer exit portal 424. FIG. 3B does not depict the voucher exit bin 420 that is attachable to the first printer 414 and the voucher exit portal 418 or the sheet bin 426 that is attachable to the second printer 422 and the printer exit portal 424. The object issuer 428, object detector 430, and document processing assembly 440 are embedded in the apparatus enclosure 470. A voucher outputting assembly includes the first printer 414, the second printer 422, and the object issuer 428 and is used to output vouchers.

As shown in FIG. 3B, an issuance apparatus 40 may have two printing configurations. A first printer 414 prints the unique identifier 94 for a voucher 92, and other information, onto a voucher blank, which may be preprinted. After qualification and voucher issuance authorization are established, the unique identifier 94 value is obtained from central computer 20 in response to a signal from the issuance apparatus 40 containing session data, so as to provide a unique identifier 94 value associated with each of one or more new permanent voucher records in the central computer 20 database corresponding to each voucher generated, and to store the session data in the permanent voucher record(s) in storage unit 116. This procedure assures that all vouchers, system-wide, are uniquely identified, and future data can be added or modified corresponding to each respective identifier 94, such as upon redemption, billing, and reward provider fee payment. A corresponding voucher record for the unique identifier 94 is created in a temporary record stored in the data storage device 434. The first printer 414, such as a printing assembly for printing physical vouchers, may be included in the issuance apparatus 40 such that a voucher exit portal 418, or in some embodiments, a voucher exit bin 420 may receive the newly printed physical vouchers. A second printer 422 may include a printing assembly for printing a sheet or document in which a printer exit portal 424 and sheet bin 426 receive the sheet or document. The second printer 422 prints one or more sheets, such as a list of current rewards, reward providers, redemption locations, redemption terms, retailer sale information, advertising, a sweepstakes voucher, and/or other useful information for a user. In one embodiment, both printing configurations are implemented in a single device wherein dual trays provide for two types of sheet stock, such as for vouchers and paper sheets. Each printer 414 and 422 embodies one or more trays for resupplying consumable printing stock.

In one embodiment, an object issuer 428 includes a mechanism for issuance of a gift card, loyalty card, and the like. The object issuer 428 is used by the issuance apparatus 40 to encode, e.g., on a magnetic stripe, a radio frequency identification (RFID) tag, an optical hologram, or print bar code, and output an object. The object is, for example, a gift card, gift certificate, loyalty card, ticket, coupon, data, or other object of value. The object may be for sale at the issuance apparatus, or may be used for a reward or for any other purpose. When outputted as a reward, the object is equivalent to, serves the function of, and is deemed to be a “voucher exchangeable for a reward.” Examples of tickets include movie tickets, theater and concert tickets, museum tickets, tour tickets, and transit fare tickets, such as commuter bus tickets and other travel tickets. Examples of data include digital downloads, such as movies, books, and music, as well as data services such as reports, analyses, news, and graphics. This data may be delivered to the issuance apparatus for outputting or, e.g., to a consumer's email address. In the case of an object as a reward, an outputted object can be issued in lieu of, or in conjunction with, a voucher. In one embodiment, the object outputted by the object issuer 428 is itself a reward. In this embodiment, the outputted object as reward may be, e.g., a ticket for a museum or a retailer gift card. Alternatively, in the case of an object for sale (not issued as a voucher or reward), a consumer may purchase tickets or a gift card, outputted by the issuance apparatus. Similarly, a consumer may purchase digital downloads, as well as data services. This data may be delivered to the issuance apparatus and outputted onto a physical object such as a portable data storage device or, e.g., to a consumer's email address. In the case of any object for sale at the issuance apparatus, the value of the purchase is applied toward qualification for a reward. When making a purchase at an issuance apparatus 40, the consumer typically uses the object detector 430, described below, for payment. Although not pictured in FIGS. 3A-D, the object issuer 428 is communicatively coupled to a replaceable object supply, e.g., a stack of cards with corresponding encoding structure such as magnetic stripe, RFID tag, optical hologram, or printed bar code. One or more object issuers 428 may be installed in an issuance apparatus 40 and may employ different encoding technologies.

In one embodiment, an object detector 430 is embedded in the issuance apparatus 40. An object detector 430 may include a swipe card reader, bar code reader, radio frequency identification (RFID) detector, or other encoding technology, such that an object, including an encoded credit card, debit card, loyalty card, gift card, consumer card, smart card, or printed sheet, can be detected and decoded. An object detector 430 may be used by the issuance apparatus 40 for various purposes, such as detecting a gift card, a credit/debit card, a loyalty card, bar codes on receipts, virtual vouchers, and RFID tags on items purchased in the shopping center, for example. Object detector 430 includes an object detection assembly for detecting data on an object, such as a credit card, debit card, or loyalty card. The object detector 430 also includes a scanning mechanism for detecting an identifier, such as a bar code on a sheet, which can be used, for example, to read a virtual voucher issued online or by a distributor 90. One or more object detectors 430 may be installed in the issuance apparatus for various detection technologies, such as a magnetic strip, radio frequency identifiers (RFID), or bar codes.

The object detector 430 can be used for several marketing functions, including 1) credit card, debit card, or loyalty card use; 2) providing a way for a repeat user to bypass certain steps in the qualifying process; 3) payment for transactions, described below; and 4) automated entry of a virtual voucher code value. In the “Credit Card Transactions” mode 16 of voucher dissemination described above, a financial services company is contracted as an Outside Payer to pay for vouchers. In this mode 16, users are identifiable by their credit cards, and qualified spending amounts are validated based on credit card usage in the shopping center. In one embodiment, the credit card is validated by the issuing financial services company, and credit card transactions corresponding to the receipts are verified at the verification station 50. In another embodiment, the credit card information is traced to qualifying transactions in the shopping center. Provided that the user meets the required spending threshold, one or more vouchers are issued and the validated transaction is allocated, or associated, to the financial services company in order to bill the financial services company for the generated voucher. This “Credit Card Transactions” mode 16 of voucher dissemination utilizes the object detector 430 to enable users to simply insert the credit card, which was used to purchase goods and/or services in the shopping center, to issue a voucher.

In another embodiment, a reward system-linked encoded loyalty card, smart card, or similar object may be sponsored by a shopping center, the host administrator, or other entity. Technology on the loyalty card, such as magnetic encoding or RFID, uniquely identifies a consumer at the time of any purchase at any eligible retailer. The loyalty card may be used to link the purchase transaction data to the consumer. Upon completion of the purchase, the transaction data, including a receipt and linked to a consumer identifier, is transmitted from the retailer to the reward system database. This database, as described herein, is accessible by any issuance apparatus in the shopping center. The consumer may swipe his or her loyalty card at the object detector 430 of the issuance apparatus to view the transmitted transaction data corresponding to the consumer identifier encoded on the loyalty card. The database retrieves the transaction data for all purchases at any eligible retailer within a predetermined time period (e.g., a day) and displays the data on the user interface to expedite the process of acquiring, analyzing, and verifying the purchase data for qualification purposes. In this way, the database associates the transaction data with each receipt-issuing retailer. Thus, one or more vouchers can be quickly issued to the consumer after swiping the loyalty card at the issuance apparatus.

Alternatively, an encoding device may encode the transaction data onto the loyalty card at the point of sale (POS). The same functions of qualifying, acquiring, analyzing, verifying, and associating can be performed at the issuance apparatus without requiring a data transfer to the database from the retailer by detecting the transaction data encoded on the card. Outdated encoded transaction data can be erased from the card by the encoding device at the POS or by the object detector at the issuance apparatus in order to maintain adequate data storage capacity on the card. Antifraud methods may be used to deter fraud, such as requiring a unique code that changes daily to be transmitted to each retailer's POS system and having the unique code associated with the POS transaction data encoded on the card. Subsequently, the unique code must correspond to a valid code in the issuance apparatus in order to validate the transaction data. Additionally, a history of transactions tied to a consumer identifier and entered at an issuance apparatus can be stored in the central database. In the event additional receipts are also obtained from retailers who do not encode transactions on the card, those receipts may be processed by the document processing assembly 440 and added to one or more transactions linked to the card.

In another embodiment, a consumer may access a retailer's website via the issuance apparatus 40, using object detector 430 to make an online purchase eligible for reward qualification and payable, for example, with a credit, debit, or gift card. This function enables any retailer in the shopping center to extend its limited inventory to all merchandise it carries online, beyond physical inventory in its store, to refer customers to issuance apparatuses for reward-eligible online purchases, and to provide transaction capabilities during busy times to avoid lost sales. This function also provides the shopping center unprecedented access to its retail tenants' online sales in transactions initiated in issuance apparatuses located in the shopping center. Thus, percentage rent is increased because the transaction (sale) occurs at, and is enabled by, the shopping center and the electronic reward generation system 10. Each purchase is promoted with rewards and is counted toward reward qualification. A consumer may also purchase online tickets for various events, such as movie tickets, admission to festivals, museums, theater and concert performances, and transit tickets including commuter bus fares, tours, and other travel tickets. Similarly, a consumer may also purchase from a website digital downloads such as movies, books, and music, as well as data services such as reports, analyses, news, and graphics. This data may be delivered to the issuance apparatus or, e.g., to a consumer's email address.

### Document Processing Assembly

In one embodiment, an integrated document processing assembly 440, shown in FIG. 3B and detailed in FIGS. 3C and 3D, includes document imager 442, a document insertion slot 444, a transparent lid 446, a permeable tray 448, an antifraud document detector 450, a document marker 452, a supply of a detectable substance 454, a hinge 456 for the tray 448 and lid 446, an opening 458 for marking documents, a document mover 460, a document exit slot 462, and a document exit bin 464 (not shown). In other embodiments, more or fewer components may be used.

Referring again to FIG. 3B, the document processing assembly 440 is illustrated in the cross-sectional left view of the issuance apparatus 40. Within the document processing assembly 440, the document imager 442 is installed such that an inserted document may be imaged efficiently. In one embodiment, the document imager 442 is located at the top of the document processing assembly 440 and is pointed downward towards the tray 448.

Also illustrated in FIG. 3B, the transparent lid 446 and permeable tray 448 are shown in both the left and front views of the issuance apparatus 40. Within the document processing assembly 440, the antifraud document detector 450 is illustrated towards the front side of the issuance apparatus 40 and underneath the tray 448. Centrally located underneath the tray 448, the document marker 452 is installed within the document processing assembly 440 with an attached supply of a detectable substance 454.

FIG. 3C illustrates one embodiment of the document processing assembly 440 in greater detail. As shown, the document insertion slot 444 provides a portal for the transparent lid 446 and permeable tray 448 to be inserted into the document processing assembly 440. A hinge 456 enables the lid 446 and permeable tray 448 to remain open while in the tray-out position 482 and become closed in the tray-in position 480. A document mover 460 is a mechanism that enables the hinge 456, lid 446, and tray 448 to be inserted and removed from the document processing assembly 440. In another embodiment (not shown), the document mover 460 is a roller device that feeds a document through a belt-driven conveyor to move a document into position for the document imager 442 to capture an image of the document, to pass the document over the document antifraud detector 450, and to mark the document using the document marker 452. In another embodiment (not shown) the document mover 460 is a device, comparable to a conventional check reader with left-right motion, or a dollar bill changer with in-out or insert-eject motion, that feeds a document by motor-driven means on a pathway to accomplish the same functions. In yet another embodiment the document mover 460 is a device which enables continuous or rapid sequential feed of multiple documents, such as a device with rotating or stacked receptacles analogous to devices which read multiple compact discs, to enable rapid processing of documents. Other embodiments of document mover 460 are feasible.

In one embodiment, the document processing assembly 440 also includes an opening 458 within the tray 448 (shown in FIG. 3D). In the tray-in position 480, the opening 458 is situated such that the document marker 452 may mark the document that is placed on the tray 448. Also, the document is positioned in the tray-in position 480 so that the document imager 442 may capture an image of the document.

A user inserts a document, such as a purchase receipt, into the document processing assembly 440 in which several operations are performed on the document before the document is returned to the user. The document mover 460 may be used to move a document from an insertion slot 444 to the other components of the document processing assembly 440 and then to exit. An antifraud document detector 450 is used to detect a document that has previously been inserted in any issuance apparatus 40. In the embodiment shown, document imager 442 is used to create a digital image of an inserted document, and a document marker 452 is used to mark the inserted document with a machine-detectable mark such that the document can be identified as a marked document by the antifraud document detector 450 upon reinsertion into any issuance apparatus 40. In one embodiment, the machine-detectable mark is a pattern that may be recognized by pattern recognition software.

FIG. 3C also illustrates the document mover 460 in further detail in one embodiment. In the tray-out position 482, the document mover 460 enables a user to place a document over the opening 458 in tray 448. The tray 448 enables a document the size of a typical purchase receipt to be firmly secured upon lowering of the transparent lid 446. The tray 448 further enables the application of a machine-detectable mark on the back side of the document. When the document is moved into the document processing assembly 440, the document, facing up over the opening 458 in the tray 448, passes over the document antifraud detector 450. In tray-in position 480, the document is properly positioned for imaging by document imager 442 and marking by document marker 452. Any alternative document mover 460 may be used, such as a roller or motor-driven device, and/or a multiple receptacle device to feed one or more documents, as described above.

The opening 458 in tray 448, as shown in the embodiment in the overhead view in FIG. 3D, is of suitable dimensions and positioned in tray 448 such that, as the tray 448 moves into the document processing assembly 440 toward tray-in position 480, the opening 458 passes over document detector 450 and then stops at a position suitable for the document imager 442 to record an image of the document and for the document marker 452 to apply a mark through the opening 458. The user is instructed to position each document, such as a purchase receipt, to cover opening 458. When lid 446 is lowered, the document is held flat and the distance between a document imager 442 and a tray 448 is consistent and uniform in every pass, and centered, thereby providing for quality high resolution imaging and proper focus, and assuring a suitable image of each document by a document imager 442 for storage, transmission, verification, or other purpose. Further, opening 458 is configured to enable any size purchase receipt, issued by any retailer 84 in the shopping center 80, to be positioned correctly for imaging by the document imager 442 while being held securely by lid 446 so that the receipt cannot move out of position.

Further, opening 458 provides consistent correct positioning for uniform marking by a document marker 452 against a firm backstop, the lowered lid 446, so that a receipt of any size may be marked through the opening 458. One function of the opening 458, as a fixed position opening in the tray 448, is to avoid the need for purchase receipts of various shapes and sizes, obtained from different retailers, to be positioned mechanically by the document processing assembly 440. The result is a simple, low cost design solving the nontrivial positioning problem with respect both to imaging and marking small format purchase receipts of varying sizes. Similarly, this configuration avoids the mechanical problem of handling and moving various receipts, which are often crumpled, between devices in the document processing assembly 440. It is noted that in an alternate embodiment, the document mover is configured as a solid state and mechanical assembly that slides the lid 446/tray 448 assembly in and out. In yet another embodiment, the document mover 460 is configured to be a fixed unit with a roller or functionally similar mechanism at the entry way to pull in a document and push out a document. In other embodiments, the opening 458 may be larger or smaller and may be located at various positions within the tray 448.

In one embodiment, a document marker 452 in the document processing assembly 440 marks each inserted document, such that, upon reinsertion in any issuance apparatus, a mark applied on the document is detectable by the antifraud detector device 450. The document marker 452 applies a machine-detectable mark, substance, symbol, color, chemical, or other device to enable the antifraud detection by 450. A refillable or replaceable substance supply 454 is provided.

For antifraud purposes, an antifraud document detector 450 in the document processing assembly 440 detects prior insertion of a document in any issuance apparatus, wherein a machine-detectable mark, substance, symbol, color, chemical, or other device is employed for antifraud detection. Examples of detectors include a magnetic ink sensor, a scanner, and a detecting head. If a document is detected as previously submitted in any issuance apparatus, the document is disqualified for qualification purposes, as described below. One or more detectors 450 may be deployed to detect any reinserted document. In an alternative embodiment, electronic document detection is employed for antifraud purposes using an image processing system including pattern recognition software, character recognition software, and/or biometric or facial recognition software. An image of the document recorded by document imager 442 and/or document detector 450, which respectively image opposite sides of the document, is processed to assess whether the same document was previously inserted in any issuance apparatus 40. In one embodiment, document marker 452 and detectable substance supply 454 may be used in conjunction with the pattern recognition software and image processing system to prevent fraudulent use of the electronic reward generation system. In another embodiment, an image of the printed pattern of the receipt, or other proof of purchase, is used by the pattern recognition software and image processing system for validation purposes. Thus, no further marking is required in this embodiment because the uniqueness of each receipt is leveraged to prevent fraudulent use of the electronic reward generation system.

Further for antifraud purposes, in one embodiment, an evaluation of images acquired by user imaging device 402, with or without use of biometric or facial recognition software, determines if a document has previously been submitted in a given time period. A document is screened, or a suspected fraud is confirmed, by visually or digitally linking facial appearance and/or biometric data with at least one user image associated with a document submission from a previous session. A user image match with at least one prior session anywhere in the system can confirm a resubmitted document and is sufficient to reject a fraudulent document. Facial recognition or biometric software is suitable to automate this task. With respect to privacy, it is not necessary to identify a user for fraud prevention, but only to tie a user's image or biometric data to prior document submissions. In the event of repetitive fraud, evidence submitted to law enforcement need not be further analyzed by the host for identification purposes.

### Verification Device and Reward Provider Device/Station

Referring again to FIG. 2A, a verification device 50 communicatively couples with an issuance apparatus 40. In one embodiment, the reward provider device/station 60 is communicatively coupled with the host administrator central computer 20.

A verification device 50 receives issuance apparatus session data, including consumer data input and one or more document images from an initiating issuance apparatus. The verification device 50 displays input data and one or more of the document images on a graphical user interface on the verification device 50. A spending total is calculated based on the consumer data input and/or the images of the documents. Invalid documents or purchases are rejected. Voucher(s) are issued dependent on whether qualification requirements, including the threshold criterion described above, are satisfied. In response to this determination, a signal coupled with session data is transmitted from the verification device 50 to the initiating issuance apparatus 40 either authorizing or rejecting the issuance of voucher(s). The received session data, including the transmitted signal, is stored for the shopping center 80 by the verification device 50 and transmitted to the central computer 20, where, if authorized, a voucher identifier value is returned to initiate voucher printing and issuance. If not authorized, data may be retained for anti-fraud purposes, including a user image and receipt images.

In a typical embodiment, a verification device 50 is operated by a shopping center employee, for example at a customer service booth, thereby enabling control of voucher issuance authorization to be maintained by the shopping center on behalf of its retailers. Alternatively, in instances where, for example, several shopping centers operate under a single ownership, a centralized station can verify documents transmitted from the issuance apparatuses located at one or more of the shopping centers using communication channels, such as the Internet.

Session data is transmitted from an issuance apparatus 40 to a verification device 50 using an I/O communication device 436 or data transmitting device 438. At the verification device 50, a verifier person compares the receipt amounts entered by the onsite consumer 88 with the images of the receipts captured and confirms that required criteria, such as a valid date, valid retailer, and correct amount, have been satisfied. Using a graphical user interface on the verification device 50, the verifier person may disqualify any invalid receipt. In one embodiment, an image processing system with optical character recognition software may be used in the verification device 50 to perform the abovementioned functions on the captured document images. In response to disqualifying an invalid receipt, the verification device 50 deducts the disqualified receipt amount, adjusts the qualified receipt total, compares the revised total to the qualifying threshold, calculates a number of vouchers to issue, and displays the results on a graphical user interface to the verifier person who, in turn, selects an appropriate message to transmit to the onsite consumer 88 at the issuance apparatus 40, either approving or rejecting the receipt verification request and specifying a number of vouchers, if any, to be issued. In one embodiment, an appropriate message is selected at the verification device 50 and transmitted to the issuance apparatus 40 for presentation to the onsite consumer 88. A data storage device at the verification device 50 stores the session data for the shopping center 80.

A reward provider (or station) 60 may or may not employ a reward provider device to redeem vouchers. A reward provider device is convenient for some, but not necessarily all reward providers, on account of employees, number of POS registers, and other factors. A reward provider device, connected to the host administrator central computer 20, receives an indication of the authorization or denial of the redemption of vouchers while the authorization or denial is stored in a database in the host administrator central computer 20. A reward provider need not employ a reward provider device connected to the central computer 20 to redeem a voucher because, in producing vouchers, methods such as printed images of users, special links, complex designs, and timely design changes help ensure that the electronic reward generation system 10 is not abused.

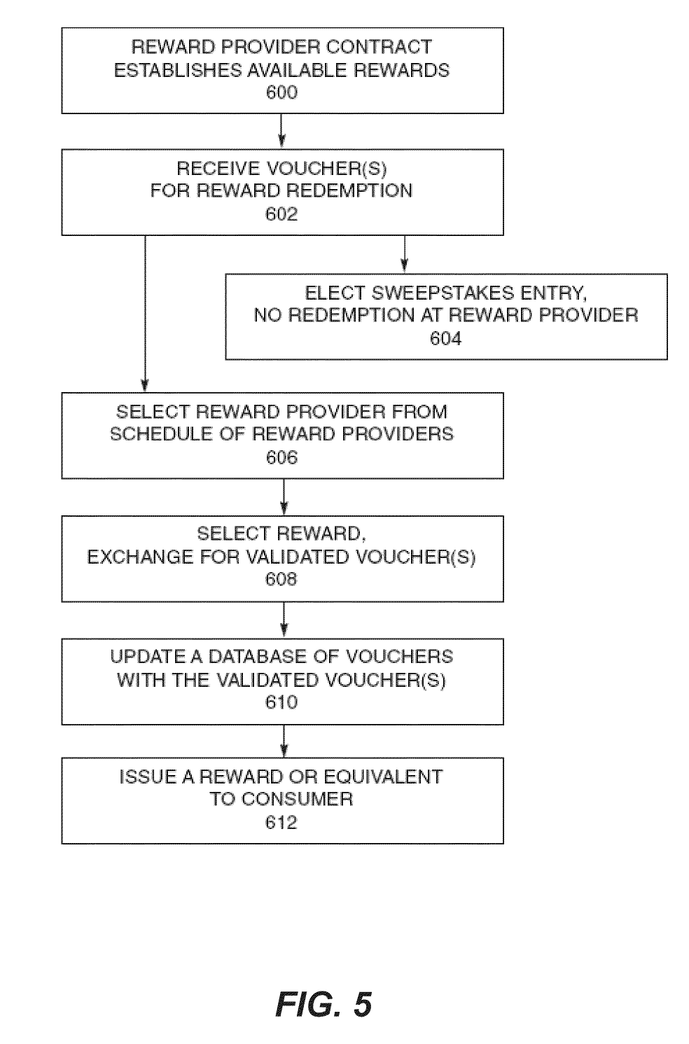

In another embodiment at a reward provider (or station) 60, a detection method to authenticate preprinted vouchers includes using a stand-alone device for detecting UV links, complex designs, die cuts, and other methods which are difficult or uneconomical to counterfeit. Voucher redemption steps are described below and depicted in FIG. 5. Further, tracking of voucher redemption occurs separately from these anti-fraud measures. A reward provider device also may be configured to record vouchers, for example, to enable convenient tracking of redeemed voucher identifiers and totaling of amounts for a reward provider to submit for payment of reward fees.

### Electronic Reward Generation

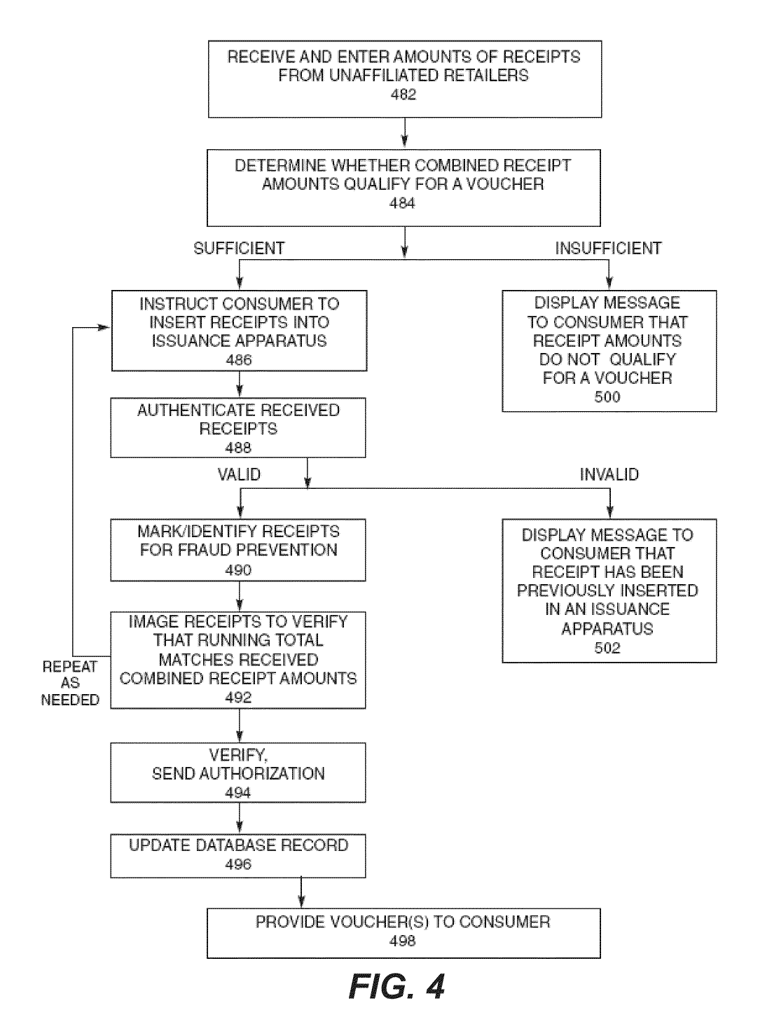

Referring now to FIGS. 4 through 5, illustrated are flowcharts describing how rewards in a physical commerce center are generated in a physical commerce center. As mentioned above, consumers, or users of the electronic reward generation system 10, may obtain vouchers in many different ways. FIG. 4 illustrates the “Shop First” voucher dissemination mode 12, in which a consumer purchases goods and/or services from retailers associated with a shopping center. Other voucher dissemination modes, as described above, may be used to obtain vouchers, including the “Outside Payer” mode 14 in which completion of a market research survey results in the issuance of vouchers, “Credit Card Transactions” mode 16 in which the transactions performed in the shopping center 80 at retailers 84 are analyzed using the issuance apparatus 40 to obtain vouchers, and “Reward First” mode 18 in which a prospective visitor 86 receives a voucher or a virtual voucher from a distributor 90 through physical issuance, an e-mail, postal mail, social networking service, text message, and the like. Vouchers from different modes of voucher dissemination may be combined and/or pooled by consumers to maximize the generated reward.

In the Shop First mode shown in FIG. 4, receipt amounts are received from unaffiliated (or disparate) retailers and entered 482 by the user into the issuance apparatus 40 via a data entry device 406 as illustrated in FIG. 3A, such as a touchscreen device. In other embodiments, the receipt amounts may be scanned by an image processing system with optical character recognition software, or may be transmitted from a retailer, e.g., a POS system. In a typical embodiment, in entering the receipt amounts, a user may be asked questions about each receipt, such as name or category of retailer, how many receipts will be processed, and the like. A running total of the entered amounts is displayed on the graphical display 404 of the issuance apparatus 40 to indicate whether the sum or other assessment of submitted receipts reaches the qualification threshold.

It is then determined 484 at issuance apparatus 40 whether the combined receipt amounts are sufficient to qualify for one or more vouchers. This determination may be based in part on a threshold supplied by the management of the shopping center, by usage of the electronic reward generation system 10, or other criteria. In one embodiment, the receipt amounts may only include same-day transactions. In other embodiments, transactions during a certain time period (e.g., the past week) may be accepted. These criteria are adjustable at any time by the management of the shopping center and are communicated from the host administrator central computer 20, illustrated in FIG. 2A, to the issuance apparatus 40.

If the combined receipt amounts are determined 484 to be insufficient, a message is displayed 500 to the consumer indicating that the receipt amounts do not qualify for a voucher. If the combined receipt amounts are determined 484 to qualify for a voucher, the consumer is instructed 486 to insert the receipts into the issuance apparatus 40 for imaging. As already described above, this involves, in one embodiment, pulling out the tray 448 from the document processing assembly 440, as illustrated in FIGS. 3A-D, and placing each receipt on the tray 448 to cover the opening 458 and then lowering the lid 446 and pushing the tray 448 into the document processing assembly 440. This process is repeated until all receipts are entered. Each receipt is returned to the consumer immediately upon completion of processing.

Upon insertion, each received receipt is authenticated 488 to prevent fraud. Authentication establishes that a receipt was not previously used in any issuance apparatus 40. In one embodiment, as the receipt enters the document processing assembly 440, an antifraud document detector 450, as depicted in FIGS. 3A-D and described above, is used to detect a document that has previously been inserted in any issuance apparatus 40. If the antifraud document detector 450 detects that the receipt has previously been inserted in any issuance apparatus 40, the receipt is rejected as invalid and a message is displayed 502 to the consumer indicating the rejection. In another embodiment, pattern recognition software and/or biometric or facial recognition software are used to establish if a receipt has been previously inserted, as described above. If the receipt has not been previously inserted in any issuance apparatus, then, in one embodiment, the receipt is marked 490 by document marker 452 to prevent future fraud, and imaged 492 by document imager 442.

A button on the graphical display 404 is pressed by the user, using a data entry device 406, to indicate that all receipts have been imaged. If the running receipt total indicates qualification, the receipt images and session data are transmitted to verification device 50 to verify 494 that the entered running total matches the received receipt amounts, to verify the validity of each receipt, and to request authorization of voucher issuance. If the receipt total is insufficient, session data is not transmitted and a message is displayed to the user at issuance apparatus 40. At verification station 50, in one embodiment, using visual inspection of receipt images displayed on the graphical display and/or optical character recognition software, the receipt amounts may be verified by assessing an image of each receipt and the corresponding amount entered by the consumer. If a receipt is invalid for any reason, its amount is deducted, a new total is calculated, and the quantity of vouchers is adjusted if required, in accordance with voucher qualification requirements as established by the shopping center or other authorized entity. Upon completion of verification, if and when a specific number of vouchers is authorized, or not, a corresponding signal is sent 494 to the initiating issuance apparatus 40, displaying a message with the authorization result.

If authorized, the consumer presses a button on the graphical display 404 requesting generation of the voucher(s), which initiates transmission of session data from the issuance apparatus 40 to the database in the central computer 20 to create 496 a new voucher database record, to assign a new voucher identifier 94 for each voucher 92 to be issued, to return the value(s) of the new identifier(s) 94 to the initiating issuance apparatus 40, and to generate and issue 498 the authorized quantity of vouchers, each with its respective identifier 94. In one embodiment, during this process, the consumer may also enter additional data, for example, to request reward or shopping center sales information by e-mail, or obtain a printed list of available rewards and reward providers to redeem the voucher(s).

FIG. 5 illustrates redemption of vouchers, in one embodiment. As described above, a reward provider (or station) 60, as illustrated in FIG. 2A, may be used by an onsite consumer 88 or offsite prospective visitor 86 to redeem vouchers. Prior to redemption, a set of reward providers is contracted 600 to offer rewards on agreed terms, including reward fees. One or more vouchers, issued in any of several voucher dissemination modes, are received 602 for reward redemption. The voucher holder selects 606 any available reward provider, as listed in issuance apparatus 40, or, in one embodiment, may elect to retain one or more vouchers to enter a sweepstakes 604, if offered. An unexpired voucher may be used, as a reward, for redemption at a reward provider or as a sweepstakes entry, but not both. Each voucher may be validated by using a device or method at reward provider (or station) 60, as described above. In one embodiment, the validation process employs a lookup to a database stored in a host administrator central computer 20. After validation, a reward is selected 608 by the redeemer based on available rewards negotiated with the reward provider, and the value printed on redeemed, validated voucher(s). Subject to the reward provider contract, a reward may have any value, and any number of vouchers may be redeemed. A database of vouchers is updated 610 for each redeemed voucher. Finally, in one embodiment, a reward is issued 612 to the consumer. In another embodiment, suitable for a large store, one or more vouchers are exchanged for a store gift card or certificate matching the store's POS system, to use at any store register. In another embodiment, a sweepstakes entry is the reward, providing a voucher holder a chance to win a prize in lieu of another reward. In a typical embodiment, vouchers may be redeemed at any authorized reward provider, including at any reward provider or shopping center in the system, as described in further detail below. Because many reward providers are located in the shopping center, many redeemers will spend additional money at the time of redemption. Thus, voucher redemption further drives traffic and spending at the shopping center.

### Reward Tracking System

Creation of a competitive reward provider market is disclosed by the abovementioned method and system of electronic reward generation. A database of rewards, the brokering of reward provider contracts, and managing a market of reward providers are elements of a reward generation and tracking system that is maintained by the host administrator central computer 20, as illustrated in FIG. 2A.

The brokering of rewards by the host administrator includes contracting one or more reward providers during one or more time periods to honor vouchers in exchange for rewards. A reward provider may be located anywhere in, or with access to, a community, not necessarily at the shopping center in which the vouchers were issued. The reward provider may be a retailer, an offsite brick and mortar business, or any other business or entity.

Participation in the reward provider system is contractual, time-specific, and voluntary. Only those reward providers that elect to offer rewards participate. A shopping center retailer need not serve as a reward provider, but may elect to do so. One benefit of reward brokering is that a second marketing capability is provided, on behalf of reward providers, to attract consumers to a separate set of businesses in the voucher redemption stage, as compared to marketing for the shopping center 80 itself and a first set of shopping center retailers 84 visited in order to qualify for vouchers. A third marketing capability is established for distributors 90 under the Reward First mode, described above.

A reward provider incurs no cost to offer a reward until a consumer redeems a voucher; consequently, no advertising or marketing risk is assumed by the reward provider. Further, a consumer is attracted to the reward provider's place of business at a known cost and volume. To control costs and volume, a reward provider can bid a reward fee and negotiate a contractual limit, for example, up to 300 or 1000 voucher redemptions per time period (e.g., a month). A reward provider is compensated with an agreed-upon reward fee by the host administrator for each redeemed voucher. As an example, if a reward provider agrees to provide a free dinner in June (a $10 value), it would receive a stipulated fee of $2.50 for each of two $5 vouchers redeemed for the reward dinner in that period. The cost sustained by the reward provider for the meal (about $5) is largely, or in some cases completely, defrayed by the reward fee, while the consumer gets a $10 meal equal to the face value of two $5 vouchers. Thus, the marketing method effectively attracts consumers to the reward provider's business and is financially advantageous to the reward provider. A bid for a reward fee may be based on a percentage of the value of the voucher. In another embodiment, the reward fee may be based on a fixed value, such as the cost of providing the reward.

A list of available reward providers and rewards may be displayed and/or printed for a voucher recipient at an issuance apparatus 40 and optionally published on a host administrator or shopping center website or by other communications, further promoting the reward providers. The management of a shopping center 80 is expected to encourage its retailers 84 to serve as reward providers; however, the role of a reward provider, invoked at the voucher redemption stage, operates independently of the earlier spending, qualification, and voucher issuance stages. Nevertheless, at least some reward providers will typically be located at a shopping center, such that the reward provider system attracts consumer traffic and spending. Some voucher recipients may spend money on a subsequent visit to the shopping center in order to redeem one or more vouchers. Because each reward provider is independent of the voucher generation process described above, and in addition to automation and other reasons cited above, the electronic reward generation system 10 is able to function without requiring active operational involvement of retailers 84 at the shopping center 80. Furthermore, the electronic reward generation system 10 is enabled to operate at the shopping center level, not at the retailer or POS level, thereby providing a range of marketing capabilities, convenience, and economic advantages otherwise unavailable to a retailer.

Unlike a coupon, which is distributed in advance of a purchase and which operates by enticing a consumer to redeem a coupon to encourage spending, the electronic reward generation system 10 attracts consumers to spend first in the “Shop First” mode 12 of voucher dissemination before receiving vouchers. Because vouchers are redeemed independently of voucher qualification and issuance, this method often generates two visits to a shopping center 80, instead of one. Moreover, because a reward fee, payable to a reward provider upon voucher redemption, is paid from revenue originally generated by visitor spending or by other Outside Payer sources, significant voucher revenue is recycled in this system as fees to attract and pay reward providers to provide quality rewards, often at little or no cost to the reward providers. This additional benefit of the electronic reward generation system 10 improves the quality of rewards, thereby attracting repeat and habitual consumer visits to the shopping center and sustaining reward variety and quality over time.

The electronic reward generation system 10 provides ways for the host administrator to broker, negotiate, and supply rewards; manage reward providers; administer reward-related contracts, transactions, and data; and disseminate and track vouchers that are exchanged for rewards. A reward provider market is thus created to enable a pool of prospective reward providers to negotiate rewards, fees, and other terms such that any prospective reward provider may be selected to participate in the marketing system. Participation is regarded as a desirable marketing opportunity with little or no risk, yet is restricted by a limited number of available positions in a given timeframe. The effect is to form a competitive marketplace for businesses to serve as reward providers. Reward fees may be bid upon, and favorable terms for desirable rewards may be agreed upon to the advantage of the host administrator, the shopping center, and consumers. Selection of reward providers is designed to ensure a diverse mix of attractive rewards, as well as favorable rates for reward provider fees, and a robust electronic reward generation system 10.

The electronic reward generation system 10, including the reward provider market and marketing system, may also serve as an alternative to advertising, yielding benefits to the shopping center, retailers, reward providers, as well as consumers. Using this system as an alternative to traditional image and incentive advertising, similar benefits and advantages of advertising are achieved, such as driving traffic, promoting consumer spending, cultivation of positive consumer relations, and brand awareness, using the methods described above.

Typically, a reward provider is contracted by the host administrator to provide one or more rewards in a designated time period. The holder of one or more valid vouchers may redeem vouchers for any reward offered by a reward provider under contract. Reward providers may include retailers, service businesses, the shopping center, and the host administrator. A reward provider may offer as a reward any form of value, including goods, services, data, meals, food, experiences, entertainment, sweepstakes participation, or valuable information. Data may include digital downloads, such as movies and music, as well as data services such as reports, analyses, news, and graphics. This data may be delivered to and outputted by the issuance apparatus or, e.g., to a consumer's email address. A reward may also be made available in the form of a gift card, gift certificate, discount coupon, ticket, or other reward means. A choice of one of several rewards is offered in a given time period. Sets of available rewards typically vary from time to time. For example, in the month of January a voucher recipient may choose one of a free restaurant meal, movie, admission to a concert or museum, a personal service, a product, a sweepstakes entry, or a price discount for merchandise. In the next month a different set of rewards may be offered by the same or different reward providers. By contracting with a plurality of reward providers in sequential time periods, rewards are rendered interesting, fresh, and valuable to consumers, and rewards remain desirable year-round.

A reward provider may elect to offer a reward in exchange for one or more vouchers such that the value of a reward reflects the number and value of vouchers redeemed. Vouchers of various values may be issued, as encoded on each voucher, and/or multiple vouchers may be combined, enabling a reward provider to offer rewards of different values. A gift card or other object of value may also be issued to serve as a voucher or a reward. For example, an object may be exchanged for any goods, services, or value with any business which honors the object. In such a case, the selection of rewards is virtually unlimited. Consumers are expected to check regularly which rewards are available and, at the issuance apparatus or online, may request reward updates by e-mail. E-mail addresses are a valuable marketing asset generated by the disclosed configuration.

### Reports

In the receipt entry step 482, the issuance apparatus 40 provides a method for a consumer to associate with a specified retailer 84 or a retailer category each spending transaction or receipt, including its amount as well as a digital image of each receipt as proof of spending per retailer 84. This consumer action method associates receipts mostly with a few specific large stores, such as anchors, while the remaining receipts are collectively assigned by the consumer to a category, such as “Restaurants” or “Other Stores.” For these receipts associated on a category basis, verification device 50 provides a software-driven method of associating each remaining receipt with its corresponding individual retailer 84, comprising additional session data which is transmitted to the database in central computer 20. The verification device 50 links each receipt image to the receipt-issuing retailer listed in a database. These links, or associations, may be performed by a shopping center employee on a display at the verification device 50, in one embodiment. In another embodiment, pattern recognition or optical character recognition software is used to make the associations. To expedite the verification process, the associations may be made at a later time after the verification process on another machine, in a further embodiment. Upon completion of the associations, data about verified purchases may be gathered at the central computer 20 to create reports, including calculating precise consumer spending on a per retailer 84 basis, based on documented evidence. This method provides a way for shopping centers to allocate various costs on a per retailer 84 basis, which may be aggregated in a billing period (e.g., monthly).

For example, receipts verified at a verification device 50 may come from various retailers 84, such as an anchor store. The exact amount of spending at the anchor store, as well as a total at all retailers 84, on a per session, per month, or per year basis, may be easily computed, providing a basis for determining per retailer percentages of total spending among consumers under the Shop First mode using the electronic reward generation system 10. The collected retail sales data includes information to identify a particular sale for later verification against submitted receipts. The information may include retailer identification, transaction identification, an amount, and date of transaction. Receipt images, organized per retailer 84, may be posted on the host administrator's website or otherwise communicated, enabling each retailer to audit and verify that its share of costs accurately corresponds to receipts for actual spending in its store. Since retailers receive spending for purchases before vouchers are issued, this method eliminates marketing risk for retailers 84, as they pay only for vouchers associated with paid purchases and corresponding documented receipts.

Using the retail sales data collected, the management of the shopping center, or an authorized entity, may analyze the retail sales data to allocate system costs among individual retailers 84. For example, costs for vouchers issued under the Shop First mode may be divided among retailers 84 in direct proportion to each retailer's share of total consumer spending in the system in a time period, or the shopping center may contribute a share of costs and the balance is then divided pro rata among retailers. Costs derived from other voucher dissemination modes, such as Outside Payers including surveys, Credit Card Transactions mode, and Reward First sales to distributors, are not charged to retailers 84, meaning that the system generates more vouchers than are paid for by the retailers 84.

Sales data, coupled with voucher issuance, consumer and other data (e.g., from other dissemination modes), enables compiling of reports for various purposes, including spending and voucher issuance volumes connected to retailers, time periods, shopping centers, and the like. The reports may vary in detail—from a basic inventory of available vouchers, identified by their unique identifiers, to a more complex report on the usage of vouchers issued in several dissemination modes, and the redemption of vouchers among various reward providers. These reports enable tracking the usage of the electronic reward generation system as well as consumer behavior, which is useful for the shopping center management. Reports are also useful for obtaining payments, under the Shop First mode, in direct proportion to actual spending on a per retailer 84 basis. It is noted that in one embodiment, the electronic reward generation system 10 is configured to collect retail sales data directly from retailer point of sale systems to enable qualification for rewards and compiling of reports.

An advantage of the electronic reward generation system 10 includes providing rewards through the issuance of vouchers. A typical voucher is a physical and tangible real world item that is electronically represented in a database as described above. The issuance of vouchers transforms the electronic representation of the voucher into a physical voucher exchangeable for tangible, real world rewards. This beneficially enables management of shopping centers to provide effective incentives to consumers while electronically tracking the usage of the vouchers as they are transformed from electronic representations to physical vouchers exchangeable for rewards.

The disclosed configuration is useful for any organization, system, enterprise, endeavor, or entity, herein called a beneficiary organization, for which a reward, inducement, or incentive may evoke desired human behavior. The function of rewards to evoke human behavior is analogous to a tax system designed to achieve goals by influencing behavior using economic leverage. The electronic reward generation system may operate on behalf of any beneficiary organization for which 1) issuance of rewards is useful; 2) qualification criteria can be established, consistent with automation and methods as set forth in this specification of the disclosed configuration; and 3) a set of rewards of any kind, or a reward provider market, may be organized. Evidence or documentation of qualification criteria may occur in many ways, including 1) achieving measurable thresholds (attendance, performance, goals, achievements, e.g., school grades; manufacturing or productivity levels; sales results; market penetration; quotas; social or civic purposes); and 2) competitions (athletics, contests, spelling bees). Scenarios for which the disclosed configuration may be useful include: 1) employment and employees (salespeople, labor productivity, training; efficiency, idea generation; non-monetary compensation; inducing hard work); 2) therapy, drug recovery, rehabilitation; behavioral, motivational, and inspirational settings; 3) education at all levels, e.g., learning inducements; 4) promoting desired behaviors and processes (e.g., saving, spending, conserving, recycling, visiting); 5) increasing or decreasing usage (e.g., mass transit, energy, water, phone, web visits; recreation, games); 6) evoking responses, actions, patronage; 7) acquiring information, feedback, or ideas (e.g., crime leads, whistle-blowing, confidential information; cost-cutting; improvements; critiques; opinions); and 8) stimulating, motivating, and mobilizing (e.g., interest, curiosity, desire, attention; promoting volunteers, participation, teamwork). Industries and markets for which a reward system may be suitable include 1) employers; 2) business-to-business commerce (manufacturers, contractors, wholesalers, distributors; non-retail technology); 3) non-retail services (real estate, financial and investment services, insurance; law enforcement; medical and health care); 4) transportation-related (transit; automotive; travel, tours, airlines; hospitality, hotels); 5) government and public services (regulations, utilities); 6) institutional (academic and educational institutions; nonprofits; social services); 7) communications (media, advertising); 8) entertainment (sports, games, performing and visual arts); and 9) other organized human activities. For example, a sports league can establish a daily attendance goal, as an adjustable percentage of stadium capacity per member team per day of the week, and provide rewards collectively to thousands of qualifying attending fans on a given day by using an issuance apparatus at stadium exits to generate vouchers exchangeable for rewards. A water or power utility district can establish a conservation goal per household per month, measured by a recorded household meter reading, and reward each qualifying water- or power-saving household by printing a virtual voucher code on the next month's bill. A transit district can establish a bridge toll timing system, enabling daily commuters using an automated toll tracking method, to obtain a reward for commuting up to 90 minutes before or after a designated rush hour, entitling a commuter to a voucher printed on a mailed monthly toll payment statement, thereby diminishing traffic congestion. A school, factory, employer, or rehabilitation center can establish attendance, grading, or performance thresholds, using the issuance apparatus to generate vouchers for qualifying students, workers, salespersons, or patients, respectively, thereby improving education, productivity, sales, or treatment results. Rewards for some purposes may be subsidized by a sponsor or client, or by reward providers, or may be limited to a sweepstakes entry at low cost, serving to raise awareness, modify behavior, and yield improved results based on reward-based behavior modification. For claims and specification purposes herein, a beneficiary organization shall be equivalent to, and may be substituted as, a “shopping center.” Any qualifying act or event, or any determination of qualification criteria, shall be equivalent to the role of a “retailer” issuing a receipt as evidence of qualification. Any document, recordable or measurable fact, or other qualifying evidence shall be equivalent to, and may be substituted as, a “receipt.” Any form of reward, or object, or voucher exchangeable for a reward is acceptable if it is effective in influencing or evoking behavior as intended.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein, e.g., as described with respect to FIGS. 2A, 4, and 5.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiples of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled, e.g., as described with respect to FIGS. 2A, 3B, 4, and 5. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations, for example, the processes described with respect to FIGS. 2A, 2B, 3B, 3C, 3D, 4, and 5. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a shopping center, a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

The performance of certain of the operations may be distributed among the one or more processors, not only residing within a single machine, but deployed across a number of machines. In some example embodiments, the one or more processors or processor-implemented modules may be located in a single geographic location (e.g., within a shopping center, a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

It is noted that a typical voucher is a physical and tangible real world item that is electronically represented in a database as described above. The issuance of vouchers transforms the electronic representation of the voucher into a physical voucher exchangeable for tangible, real world rewards. This transformation of an electronically represented voucher into a physical voucher that is exchangeable for real world rewards is accomplished using the methods described, e.g., with respect to FIGS. 2A, 2B, 3B, 3C, 3D, 4 and 5.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosed configuration. This description should be read to include one or at least one and the singular also includes the plural unless it is obvious that it is meant otherwise.

Upon reading this disclosure, those of skill in the art will appreciate still additional alternative structural and functional designs for a system and a process for electronically generating rewards through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. An apparatus for issuing vouchers in an electronic reward generation system, the apparatus comprising:
a user interface;
a document processing assembly configured to receive a plurality of receipts, each receipt corresponding to a transaction completed at a retailer within a predetermined time period, each retailer associated with a physical shopping center, at least two retailers unaffiliated with one other;
a voucher outputting assembly configured to output vouchers exchangeable for rewards; and
a computer readable medium having instructions embodied thereon, the instructions executable by a processor communicatively coupled to the user interface, the document processing assembly, and the voucher outputting assembly, the instructions comprising a method of voucher qualification, the instructions when executed cause the processor to:
analyze each receipt of the plurality of receipts to determine a value of the transaction corresponding to the receipt,
sum or assess the value of the transactions for the plurality of receipts, and
determine, in response to the summed or assessed value and other requirements satisfying one or more threshold criteria, a corresponding quantity of vouchers exchangeable for one or more rewards;
wherein the voucher outputting assembly outputs, in response to the determined quantity, the quantity of vouchers and the user interface outputs, in response to not satisfying the threshold criteria, information corresponding to meeting one or more threshold criteria.

2. The apparatus of claim 1, wherein the document processing assembly is further configured to receive receipts from the shopping center comprising two or more non-contiguous locations.

3. The apparatus of claim 1, wherein each receipt of the plurality of receipts is analyzed using an optical character recognition system to determine a value of the transaction corresponding to the receipt.

4. The apparatus of claim 1, further comprising an object detector configured to receive data from an object, to correlate the received data from the object to a qualifying transaction completed at a retailer, and to associate the received data from the object with an object issuer for billing the object issuer for the outputted voucher.

5. A method for generating a voucher for a reward, the method comprising:
receiving at a computing system a plurality of receipts, each receipt corresponding to a transaction completed at a retailer within a predetermined time period, each retailer associated with a physical shopping center, at least two retailers unaffiliated with one other;
analyzing each receipt of the plurality of receipts to determine a value of the transaction corresponding to the receipt;
summing or assessing the value of the transactions for the plurality of receipts;
determining, in response to the summed or assessed value and other requirements satisfying one or more threshold criteria, a corresponding quantity of vouchers, exchangeable for one or more rewards from a reward provider; and
outputting, in response to the determined quantity, the quantity of vouchers, or outputting, in response to the summed value not satisfying the threshold criteria, information corresponding to meeting one or more threshold criteria.

6. The method of claim 5, wherein the shopping center comprises a plurality of shopping centers managed by a common entity.

7. The method of claim 5, wherein the shopping center comprises a single physical location.

8. The method of claim 5, wherein the shopping center comprises two or more non-contiguous locations.

9. The method of 5, wherein analyzing each receipt comprises qualifying the receipt for use in summing or assessing the value of the transactions for the plurality of receipts.

10. The method of claim 9, wherein qualifying the receipt comprises applying optical character recognition to determine the value of the transaction and matching the determined value with an inputted value of the receipt.

11. The method of claim 9, wherein qualifying the receipt comprises reading a code within the receipt, the code corresponding to a database entry having the determined value of the transaction, the database entry populated through a communication with the retailer in response to a completion of a transaction.

12. The method of claim 9, wherein qualifying the receipt comprises manual verification of the receipt and an inputted value of the receipt.

13. The method of claim 5, wherein the voucher is one of a virtual voucher or a physical voucher.

14. The method of claim 5, wherein the reward provider comprises any business establishment or entity unaffiliated with the shopping center or any retailer.

15. The method of claim 5, wherein analyzing each receipt comprises determining a unique retailer for each receipt.

16. The method of claim 15, further comprising allocating costs of the outputted vouchers among the determined retailers.

17. A computing system, including at least one processor, for generating rewards for consumers visiting a shopping center, the computing system comprising:
a database configured to include a plurality of entries corresponding to unique vouchers, a schedule of one or more qualification requirements, including a threshold, a plurality of entries corresponding to retailers associated with a shopping center, and a schedule of rewards and reward providers;
an analysis engine configured to:
receive data corresponding to a value of each transaction completed with a retailer associated with the shopping center,
calculate a total value corresponding to a sum or other assessment of the value of each transaction, and
determine whether the total value exceeds a predetermined threshold in conjunction with one or more qualification requirements corresponding to the schedule of one or more qualification requirements; and
an output engine configured to:
generate one or more vouchers, exchangeable for a reward from the schedule of rewards in response to satisfying the predetermined qualification requirements, and
generate a denial of qualification in response to not satisfying the predetermined qualification requirements, and
record in the database entries for the one or more generated vouchers information relating to the received data and an indication of the predetermined qualification requirements satisfied.

18. The computing system of claim 17, wherein the voucher comprises one of a virtual voucher or a physical voucher.

19. The computing system of claim 18, further comprising a first communication module configured to transmit to a device corresponding with a consumer the virtual voucher.

20. The computing system of claim 18, further comprising a voucher outputting assembly configured to output the physical voucher.

21. The computing system of claim 17, further comprising a second communication module configured to receive, issued by a retailer of the shopping center, information corresponding to a completed transaction, the information including an identification of the retailer and a transaction value of the completed transaction, the information stored in the database.

22. The computing system of claim 21, further comprising an optical scanner configured to read at least one of a bar code, an identifier of a retailer, and a transaction value.

23. The computing system of claim 17, wherein the analysis engine is further configured to recognize pattern markings for preventing fraudulent use of a previously qualified receipt.

24. The computing system of claim 17, wherein the analysis engine is further configured to recognize user biometrics for preventing fraudulent use of a previously qualified receipt.

25. The computing system of claim 17, wherein the analysis engine is further configured to receive data corresponding to a value of an object purchased using an object detector to satisfy the qualification requirement, the value of the object added to the total value, and wherein the output engine is further configured to generate the purchased object.

26. The computing system of claim 25, wherein the purchased object comprises at least one of a gift card and a gift certificate.

27. The computing system of claim 25, wherein the purchased object comprises a ticket.

28. The computing system of claim 25, wherein the purchased object comprises at least one of goods, services, data, and information at websites of eligible retailers.

29. The computing system of claim 25, wherein the object detector comprises a reader of credit, debit, loyalty, and gift cards.

30. The computing system of claim 17 wherein the analysis engine is further configured to receive a digital image of a user, the image outputted on generated physical vouchers for validation upon redemption to deter fraud, each image stored to a database entry.

31. The computing system of claim 17, wherein the analysis engine is further configured to receive data from an object, to correlate the received data from the object to a qualifying transaction completed at a retailer, and to associate the received data from the object with an object issuer for billing the object issuer for the generated voucher.

32. The computing system of claim 17, wherein a qualification requirement is satisfied by a predetermined value corresponding to an aggregation of receipts among two or more users, each user receiving receipts from one or more retailers.

33. The computing system of claim 17, wherein a qualification requirement is satisfied by completion of a shopping center survey.

34. The computing system of claim 17, wherein completion of a market research survey satisfies the predetermined qualification requirements for generating a voucher.

35. A computer-implemented method for providing a reward provider market in association with a physical shopping center, the method comprising:
enabling through at least one computer, for a predetermined time period, a plurality of reward providers to place a bid based on reward fees or other criteria for an opportunity to offer one or more rewards of a plurality of rewards to be provided to voucher holders in exchange for an issued one or more vouchers received from the voucher holder, the reward providers comprising retailers in a physical shopping center and other entities in any location;
selecting a winning bid from a reward provider of the plurality of reward providers, the winning bid securing the opportunity for the reward provider to offer one or more rewards of the plurality of rewards from the placed bids for the predetermined time period, the winning bid stored in association with the one or more rewards and the reward provider in a reward tracking database;
responsive to redemption of the issued one or more vouchers for a corresponding reward to the selected winning bid, transmitting payment of the corresponding reward fees to the reward provider as one of a plurality having the winning bid; and
recording the payment of the reward fees for the redeemed vouchers in the reward tracking database, and invalidating redeemed vouchers for further use.

36. The method of 35, wherein the reward providers place bids to offer one or more rewards in an auction in which the winning bid is selected from the placed bids with the lowest reward fees.

37. The method of 35, wherein the winning bid comprises terms, including negotiated rewards, reward value, redemption conditions, non-acceptance of expired or invalid vouchers, and reward fees, accepted from the placed bids.

38. The method of 35, wherein the winning bid comprises a selected bid from the placed bids, the selection based in part on providing a diverse mix of rewards for voucher redemption.

39. The method of 35, wherein the winning bid comprises a reward fee bid based on a percentage of voucher value.

40. The method of 35, wherein the winning bid comprises a reward fee bid based on a fixed value.

41. The method of 35, wherein the corresponding reward comprises at least one of gift certificates, gift cards, tickets, data, and other objects of value for use in the physical shopping center or at the other entities in any location.

42. The method of 35, wherein the corresponding reward comprises an entry in a sweepstakes.

43. The method of 35, wherein the redemption of the issued vouchers for a corresponding reward to the winning bid is communicated directly to the reward tracking database.

44. The method of 35, further comprising:
compiling data from the reward tracking database;
analyzing the compiled data to determine a usage of the winning bid;
reporting the usage to the corresponding reward provider.
